(19) United States
(12) Patent Application Publication
(10) Pub. No.: US 2016/0048383 A1
(43) Pub. Date: Feb. 18, 2016

(54) ISV UPDATE DELIVERY

(71) Applicant: Microsoft Technology Licensing, LLC, Redmond, WA (US)

(72) Inventors: Arunpriyaa Nachimuthu, Bellevue, WA (US); Satish J. Thomas, Sammamish, WA (US)

(21) Appl. No.: 14/458,884

(22) Filed: Aug. 13, 2014

(51) Int. Cl. G06F 9/445

(52) U.S. Cl. CPC G06F 8/65

(57) ABSTRACT

And update installer provides an ISV user interface display that allows an ISV to download manufacturer updates to a computer system. The update installer also allows the ISV to subsequently upload ISV updates that incorporate the manufacturer's updates and any additional ISV updates. The ISV update package is saved on a lifecycle system that can be accessed by a customer for installation of the ISV updates on the customer's system.

### BACKGROUND

Computers systems are currently in wide use. Some such computer systems are customized (and some of them extensively) before they are deployed at an end user's site. Such systems often also have updates which can be installed.

By way of example, some such computer systems include business systems, such as customer relations management (CRM) systems, enterprise resource planning (ERP) systems, line-of-business (LOB) systems, among others. In these types of systems, a general business system (or base system) is first manufactured by a manufacturer. Many times, independent software vendors (ISVs) make changes to the basic system offered by the software manufacturer. The ISV sells the customized system to a company, where end users use the system. The company or business often makes additional customizations, extensions or other modifications to the product they purchased from the ISV, in order to obtain their own customized deployment.

Such systems often have updates published for them. For instance, the software manufacturer may publish updates that include new releases as well as bug fixes. For instance, when new releases of the business system are generated by the manufacturer, they are often followed by a number of bug fixes that fix problems that were not fixed prior to release. The fixes can be released piecemeal, as they are generated. Periodically, however, a cumulative update package is released which includes all of the fixes generated, to that point. This may, for example, include hundreds or even thousands of fixes.

When a manufacturer releases updates, this can result in a large cost to the ISV, in order to try to implement the manufacturer's updates in the various products that have been sold by the ISV. In some cases, it has taken anywhere from several months, to nearly a year, for ISVs to implement a cumulative update package, depending upon the size of the ISV solution. It is also common for the ISV to make additional ISV updates on top of the cumulative update package, once they are implemented into the product. For an ISV to implement updates, this can involve making sure that the ISV updates are valid, with the manufacturer's product, and then implementing, deploying, and testing the manufacturer's updates and the ISV updates on top of them.

ISVs can also face another problem in implementing manufacturer updates. The delivery mechanism by which ISV updates are subsequently delivered to customers can be relatively error prone. For instance, ISV updates are often manually distributed as model updates to the ISV's customers. The updates provided by the ISV to the customer (that may be provided in order to resolve a specific customer issue) are often tracked and managed by the customer, itself. This can lead to errors, instability, and extra validation effort on the part of the customer.

These problems can be exacerbated because software manufacturers often repeatedly release additional update packages for manufactured software. In some cases, an ISV may not even be finished implementing a previous cumulative update package when the next one is released. This can make it difficult for an ISV to meet contractual obligations with its customers, that may obligate the ISV to maintain a relatively current system (with respect to implementing manufacturer updates).

The discussion above is merely provided for general background information and is not intended to be used as an aid in determining the scope of the claimed subject matter.

### SUMMARY

And update installer provides an ISV user interface display that allows an ISV to download manufacturer updates to a computer system. The update installer also allows the ISV to subsequently upload ISV updates that incorporate the manufacturer's updates and any additional ISV updates. The ISV update package is saved on a lifecycle system that can be accessed by a customer for installation of the ISV updates on the customer's system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram illustrating one example of a computer system distribution channel.

FIG. 2 is a block diagram showing one example of an update architecture.

FIG. 2A is a block diagram showing one example of an update installer in more detail.

FIGS. 3A-3B (collectively FIG. 3) show a flow diagram illustrating one example of the operation of the architecture shown in FIG. 2 in allowing ISVs to make updates to a computer system.

FIGS. 3C-3G show various examples of user interface displays.

FIGS. 4A-4B (collectively FIG. 4) show a flow diagram illustrating one example of the operation of architecture 100 in allowing customers to install ISV updates.

FIGS. 4C-4R show various examples of user interface displays.

FIG. 5 shows one example of the architecture illustrated in FIG. 2, deployed in a cloud computing architecture.

FIGS. 6-8 show various examples of mobile devices that can be used in the architectures.

FIG. 9 is a block diagram of one example of a computing environment.

### DETAILED DESCRIPTION

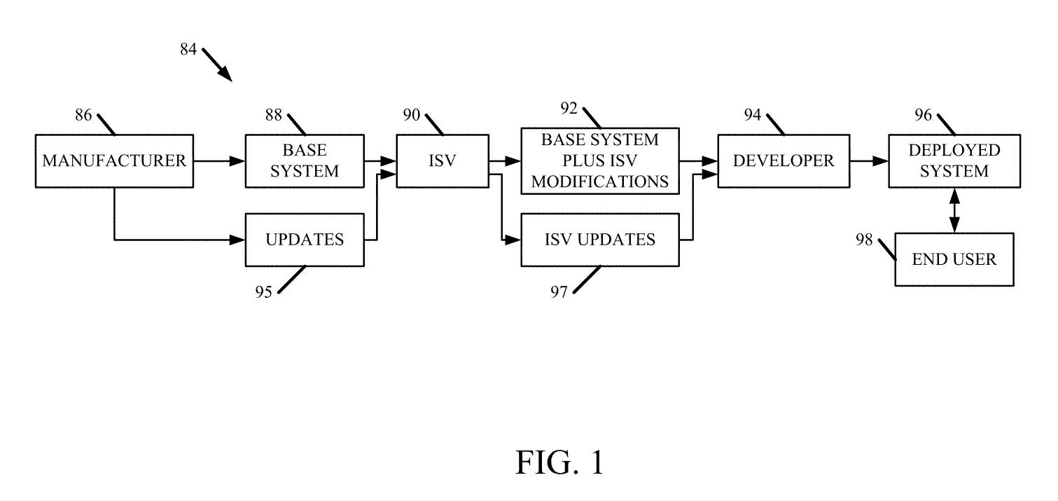

FIG. 1 is a block diagram of one example of a computer system distribution channel 84. Channel 84 includes a software manufacturer 86, an independent software vendor (ISV) 90, a developer 94 and an end user 98. Manufacturer 86 illustratively manufactures a base computer system 88. System 88 can be, for instance, a business system. ISV 90 then modifies the base system 88 to obtain the base system plus ISV modifications 92. This can be provided to a developer where it is even further modified into deployed system 96 which may be implemented and used by end user 98.

At some point, it is not uncommon for manufacturer 86 to provide updates 95. The updates may include, for instance, bug fixes, extended functionality, etc. In entering an agreement with the company of end user 98, ISV 90 may agree to maintain system 92 so that it is updated with respect to the updates 95, within a certain period of time. Thus, ISV 90 may normally obtain updates 95, apply those updates to the base system plus ISV modifications 92 and provide the updated system to developer 94, who may further customize the system. Alternatively, ISV 90 may make a set of ISV updates 97 that are provided to developer 94, who is in charge of implementing those updates into deployed system 96.

It can occur that ISV 90 is not even finished making ISV updates 97 on top of the first set of updates 95 released by manufacturer 86, when manufacturer 86 releases a second set of updates. ISV 90 may spend thousands of hours in generating the first set of ISV updates 97 (to incorporate manufacturer updates 95), where the solution provided to developer 94 is a relatively large solution. Further, the ISV 90 often relies on manual distribution of the updated model (the ISV updates 97) to developer 94 who then needs to track, and manage, deploying those fixes in deployed system 96. This can be error prone.

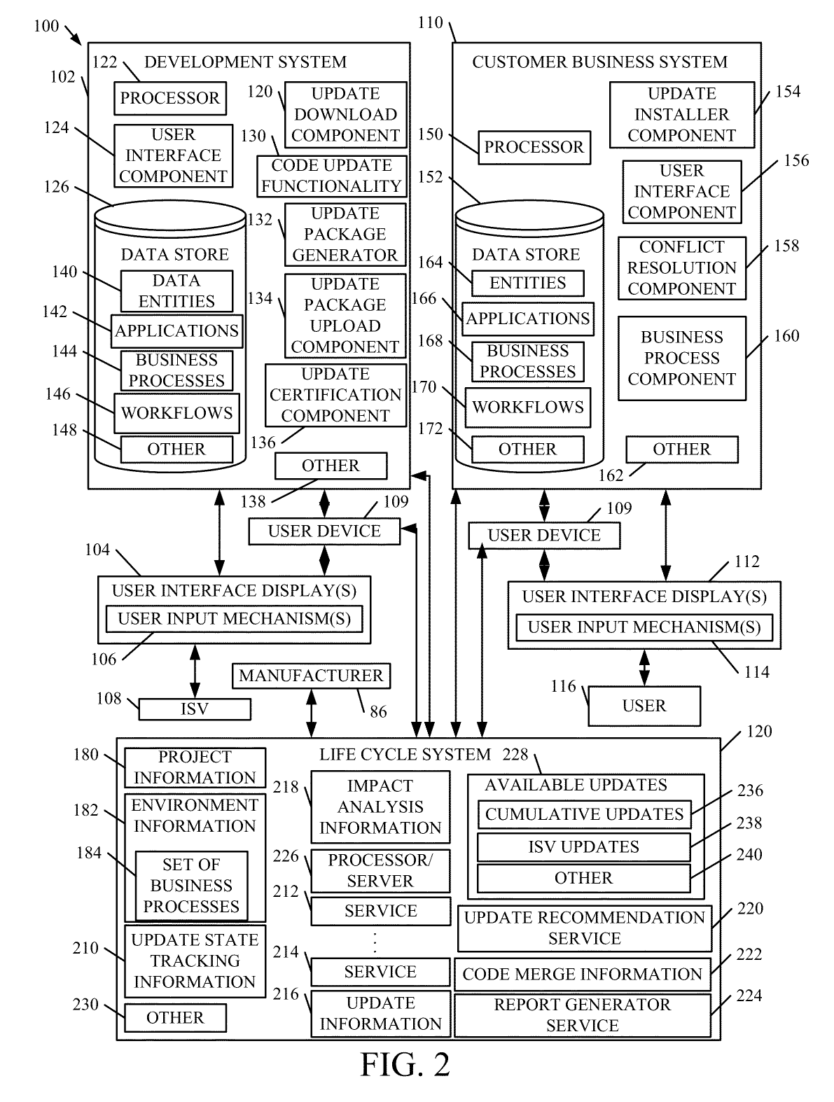

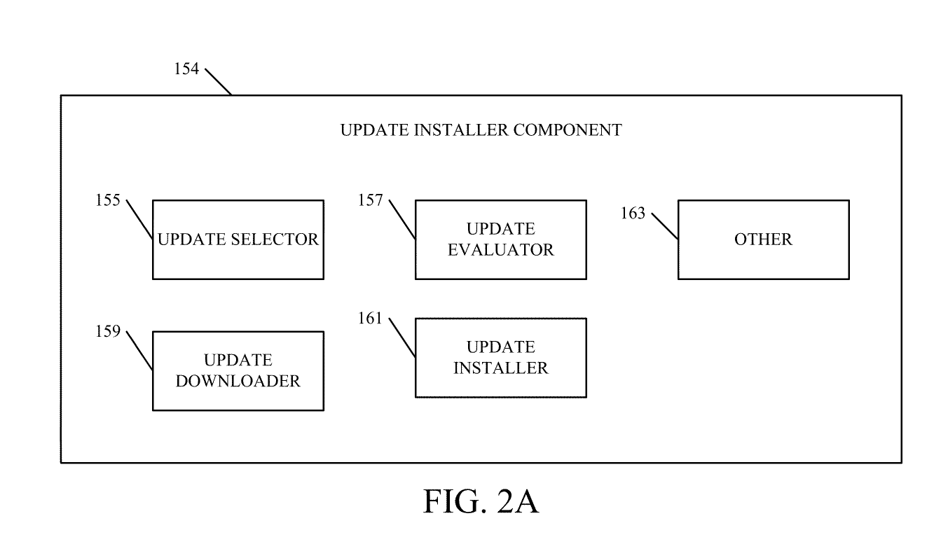

FIG. 2 shows a block diagram of one example of an update architecture 100. Architecture 100 illustratively includes development system 102 that generates user interface displays 104, with user input mechanisms 106, for interaction by ISV 108 (who can be the same as ISV 90 in FIG. 1 or a different ISV). ISV 108 can interact with development system 102 either directly, or through user device 109, and can use user input mechanisms 106 to control and manipulate development system 102 in making modifications to a base system, or on making updates, etc. Architecture 100 also illustratively includes a deployed customer business system 110. Business system 110 may illustratively be similar to deployed system 96 shown in FIG. 1. System 110 illustratively generates user interface displays 112, with user input mechanisms 114, for interaction by end user 116. Thus, user 116 interacts with user input mechanisms 114 in order to control and manipulate customer business system 110 in order to carry out the business of the organization that has implemented customer business system 110. User 116 can do this by interacting directly with system 110, or by interacting through user device 118. User 116 may also be a developer or administrator that is used to develop or administer customer business system 110.

Architecture 100 also illustratively includes lifecycle system 120. User 116 and ISV 108 can both illustratively access lifecycle system 120 either directly, or through user devices 109 and 118, respectively. Lifecycle system 120, as is described in greater detail below, illustratively allows ISV 108 and user 116 (who can also be a developer) to track issues which arise, and to determine whether user's expectations are met, when the final instance of customer business system 110 is deployed at an organization.

Before describing the operation of architecture 100 in more detail, a brief overview of some of the items in architecture 100 will first be described. Development system 102 illustratively includes processor 122, user interface component 124, data store 126, update download component 128, code update functionality 130, update packet generator 132, update package upload component 134, update certification component 136, and it can include other items 138 as well. Data store 126, itself, illustratively includes entities 140, applications 142, business processes 144, workflows 146, and it can include other items 148. ISV 108 illustratively uses code update functionality 130 in order to make modifications to manufacturer software that is released, and that is represented by the entities 140, applications 142, business processes 144 and workflows 146 in data store 126, in order to generate the ISV modifications to the base system. Update download component 128 can be used to download manufacturer updates from lifecycle system 120. ISV 108 can then use the code update functionality 130 to implement those updates in the system that was modified by ISV 108 and later deployed at the customer organization. Update package generator 132 illustratively generates an update package that includes the ISV updates, and update certification component 136 can be used to certify that the ISV updates are performed according to a given set of update procedures authorized by the manufacturer. Update package upload component 134 can be used to upload the ISV update package to lifecycle system 120.

Customer business system 110 illustratively includes processor 150, data store 152, update installer component 154, user interface component 156, conflict resolution component 158, business process component 160, and it can include other items 162. Data store 152, itself, illustratively includes entities 164, applications 166, business processes 168, workflows 170, and it can include other items 172. In one example, applications 166 illustratively include the business logic used to run business processes 168 and workflows 170 in business system 110. Applications 166 illustratively operate on data in data store 152, which can include entities 164 that represent items in business system 110. Thus, applications 166 can include a general ledger application (or other accounting applications), inventory applications, applications that allow a user to track business opportunities, track sales or production in a business system, or a wide variety of other business applications.

The entities 164, for instance, can include customer entities that represent customers, opportunity entities that represent business opportunities, inventory entities that represent inventory items, quote and proposal entities that represent quotes and proposals, etc. The data in data store 152 can include a wide variety of other entities and data, and those mentioned above are mentioned for the sake of example only. User 116 (or other users) can illustratively access customer business system 110 in order to perform activities, tasks, workflows, etc., that are done in carrying out the business of the organization that deploys business system 110.

Lifecycle system 120 illustratively includes project information 180, environment information 182 (which can include information representative of a set of business processes 184 that are used by the user in customer business system 110), update state tracking information 210, services 212-214, update information 216, impact analysis information 218, update recommendation service 220, code merge information 222, report generator service 224, processors or servers 226, available updates 228, and it can include other items 130 as well. It will be noted that, in one example, lifecycle system 120 can be in a remote server environment (such as in a cloud-based deployment). It can be continually updated even outside the cycle of updates and ISV updates. In such an example, all of the items in lifecycle system 120 can be independently updated, independent of other items or updates.

Services 212-214 can be used by various persons in order to identify, track and resolve issues that arise during various lifecycle stages of a project (e.g., from presale to implementation and maintenance). For instance, as business system 110 is designed, built, deployed and tested, the various services 212-214 illustratively allow ISVs and the developers as well as the user organization to track issues which arise, and to determine whether the user's expectations are met when the final instance of business system 110 is deployed at the organization.

User 116 can illustratively log into lifecycle system 120 to view the various information provided by services 212-214 (and other components of lifecycle system 120). In one example, for instance, services 212-214 include a service that allows a user to identify the needs of an organization and the basic functionality that is provided with a business system and generate a fit gap list that identifies the functionality or customizations that need to be made, to the business system, in order to meet the needs of the customer that is deploying the business system. The services also illustratively include a diagnostic service that allows lifecycle system 120 to identify the particular environmental information that defines the environment of the deployed business system 110. For instance, the environmental data may identify the version number and identity of the operating system, the version number of the base computer system used to implement business system 110, the particular fixes or updates that have been applied to system 110, the version number of the database and other application platforms used by business system 110, whether system 110 is in a production environment, a test environment, a user acceptance testing environment, etc., and a wide variety of other information.

In addition, manufacturer 86 can store base system 88 on lifecycle system 120, as well as any updates that the manufacturer makes to the system. Thus, available updates 228 may include cumulative update packages 236, or individual updates, ISV updates 238 that are made by ISV 108, or other updates 240. Thus, when manufacturer 86 releases updates, they can be stored as available updates 228 in lifecycle system 120. They can then be accessed by ISV 108, as is described below.

User 116 can access lifecycle system 120 to view project information 180 that defines the user's projects, environmental information 182 that includes the environmental data mentioned above, as well as an indication of the set of business processes 184 that are run on business system 110, update tracking information 210 that identifies the update state of business system 110 (for example which updates have been applied and when), update information 216 that indicates available updates 228 or detailed information corresponding to updates that have been installed, update recommendation information provided by service 220 that recommends updates for business system 110 based upon the information gathered from business system 110, impact analysis information 218 that shows the effect that selected updates have on business system 110 (such as the affect on the business processes 168, the objects, layers, etc.), code merge information 222 that shows the effect of automatic conflict resolution, and report generator service 224 that can be used to generate various reports.

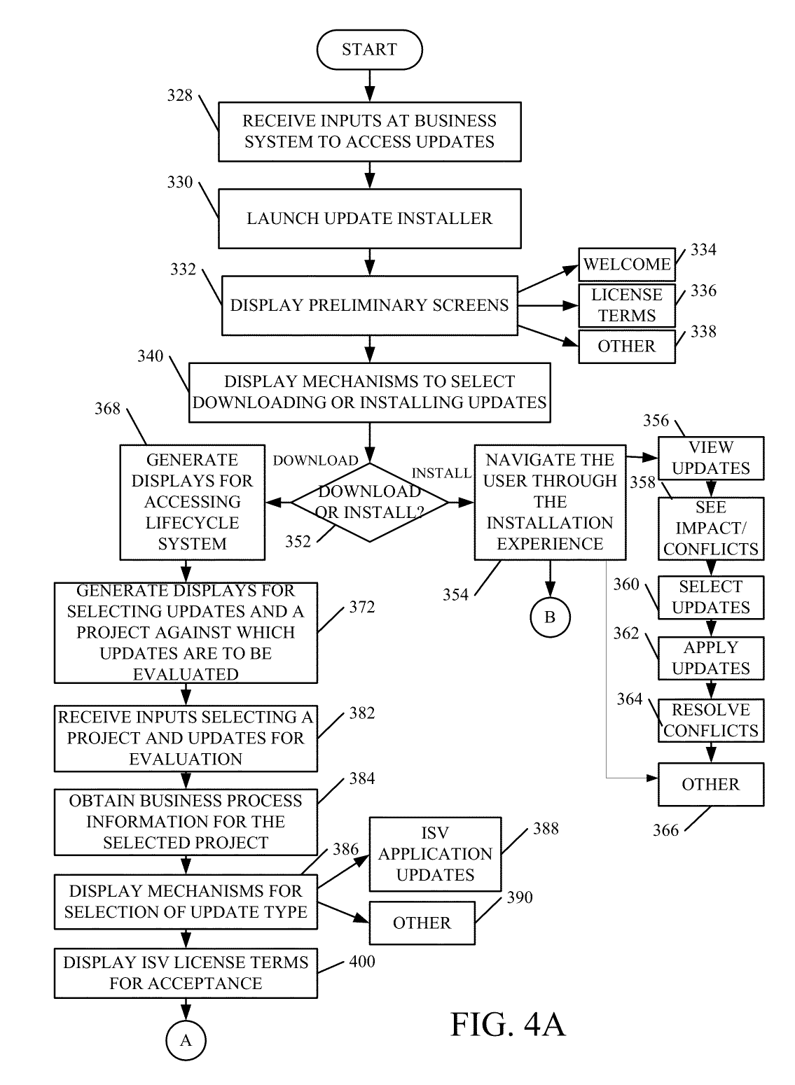

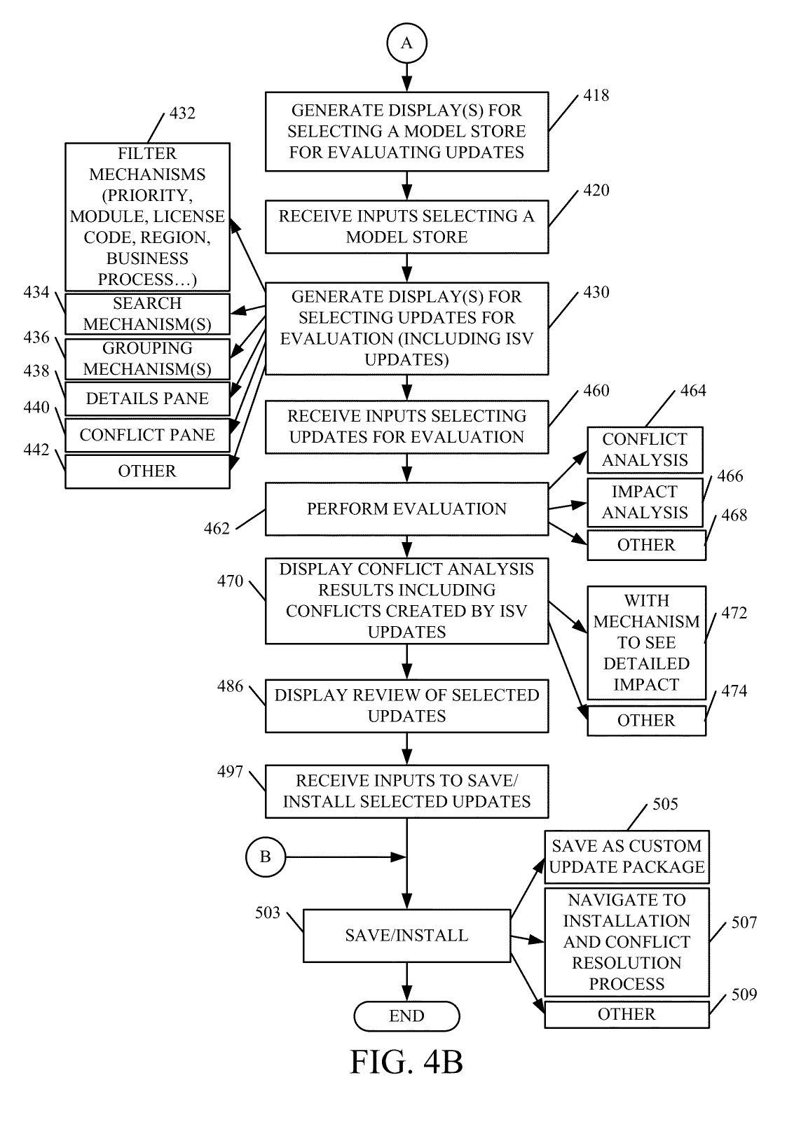

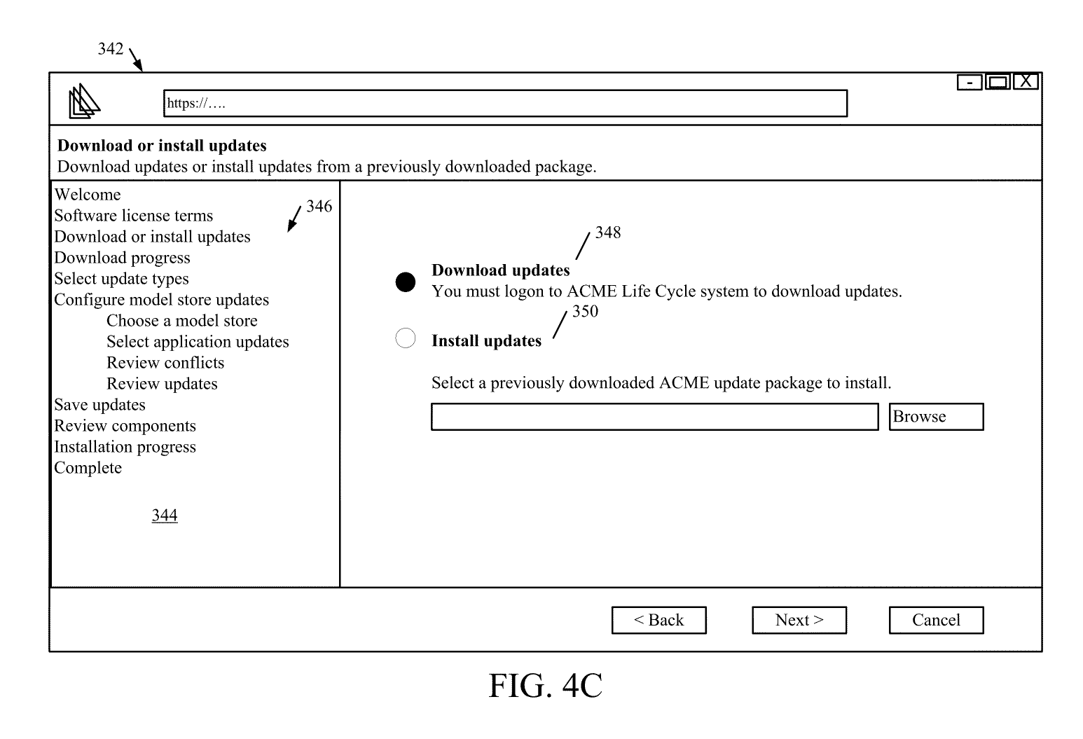

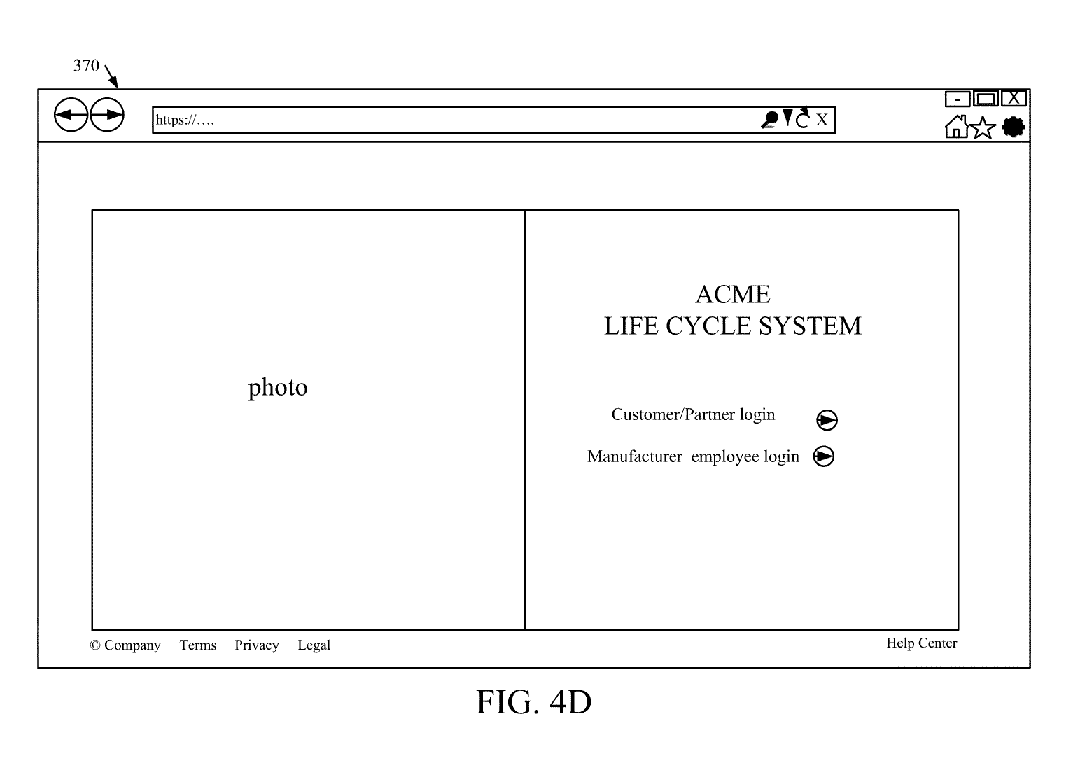

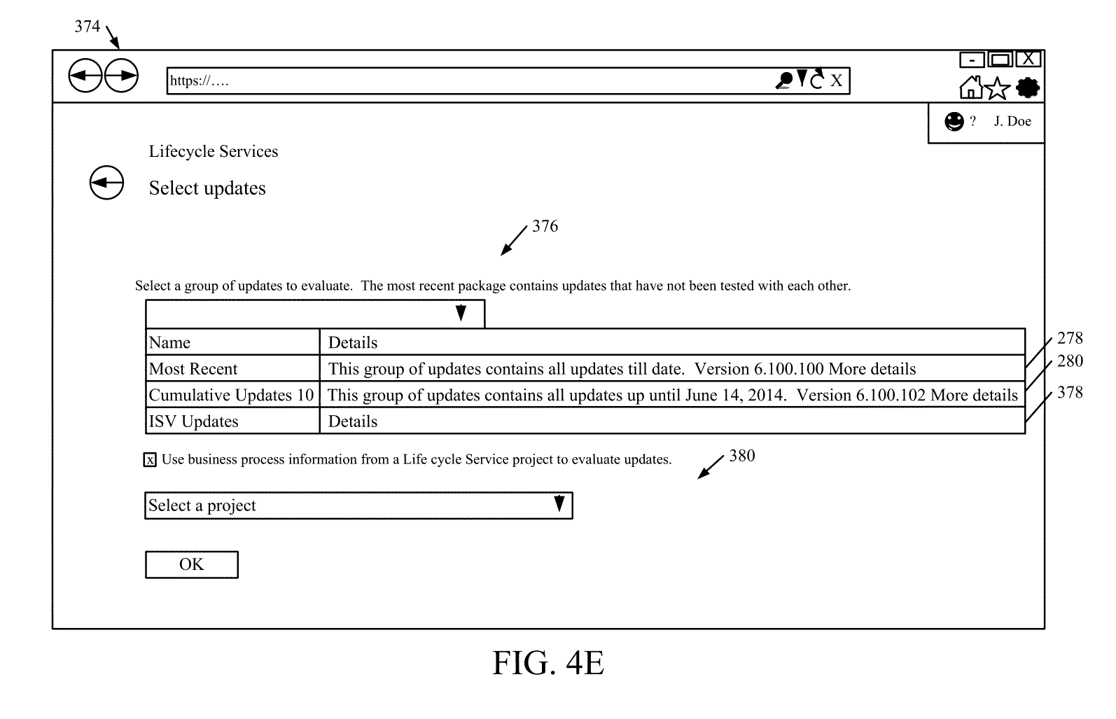

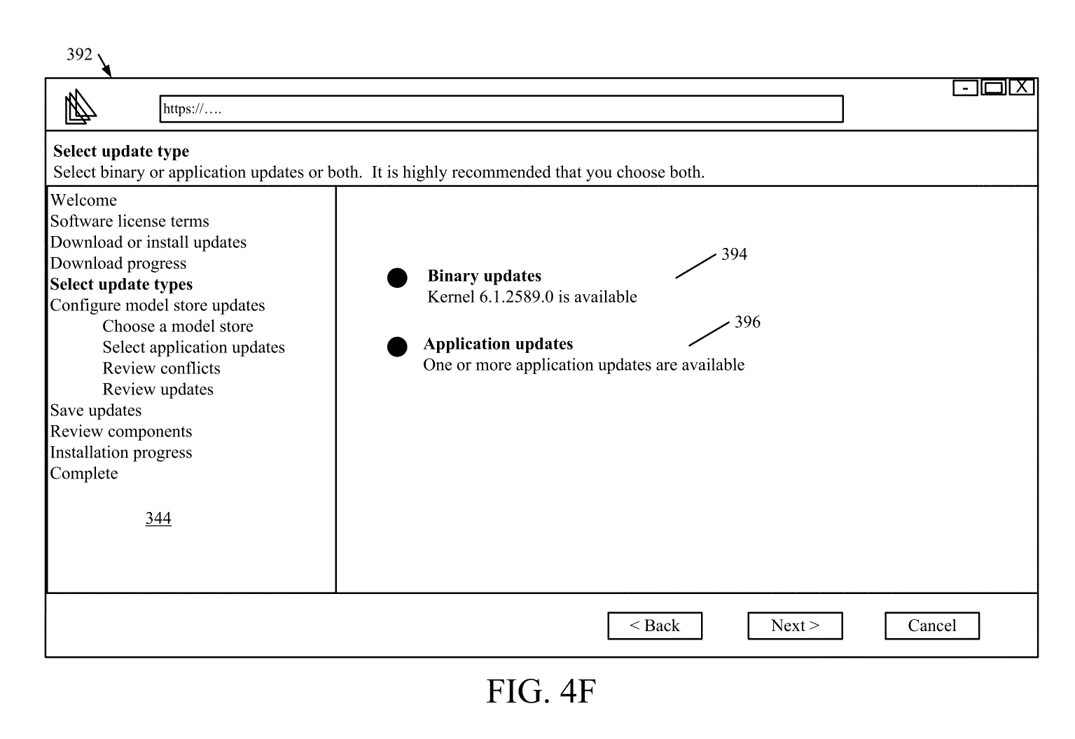

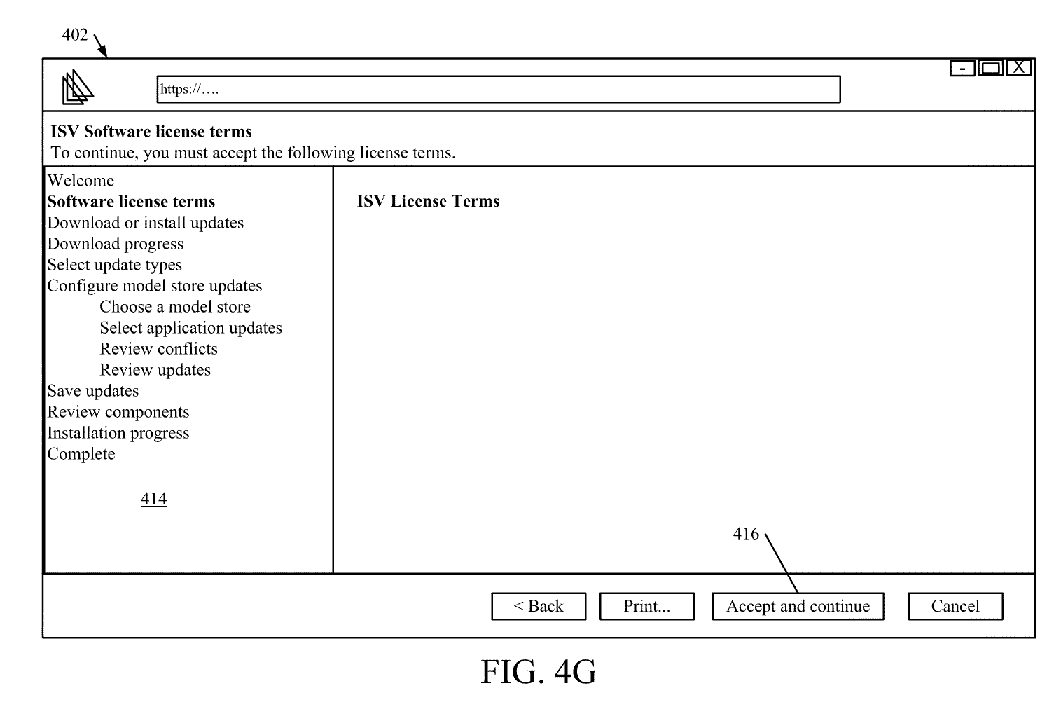

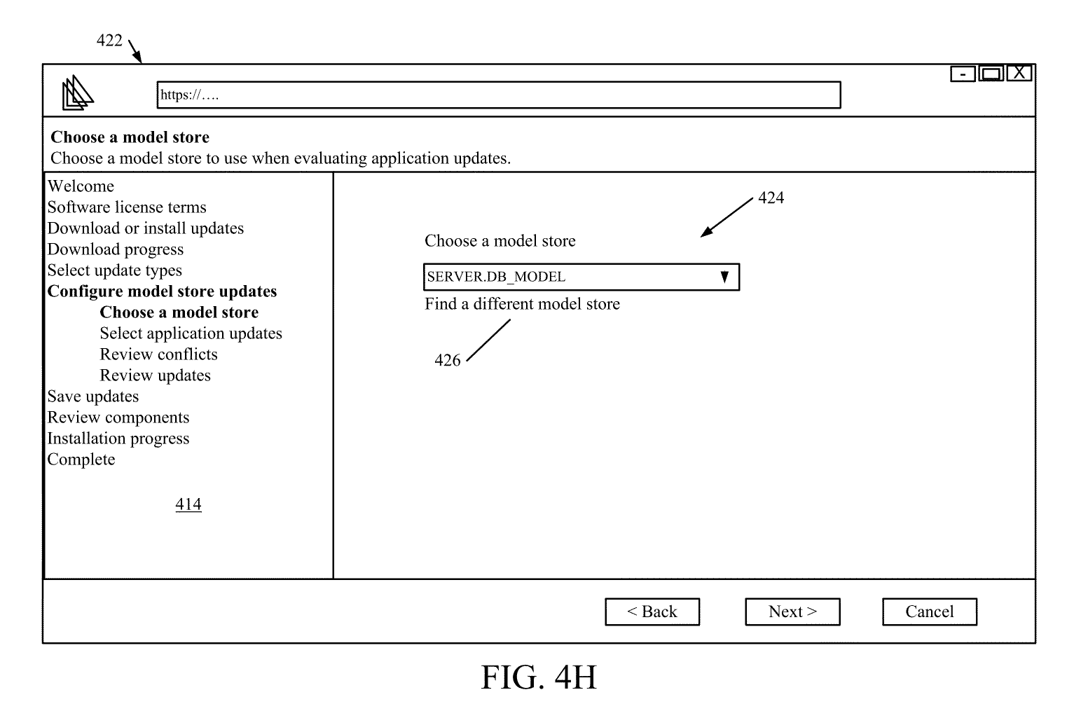

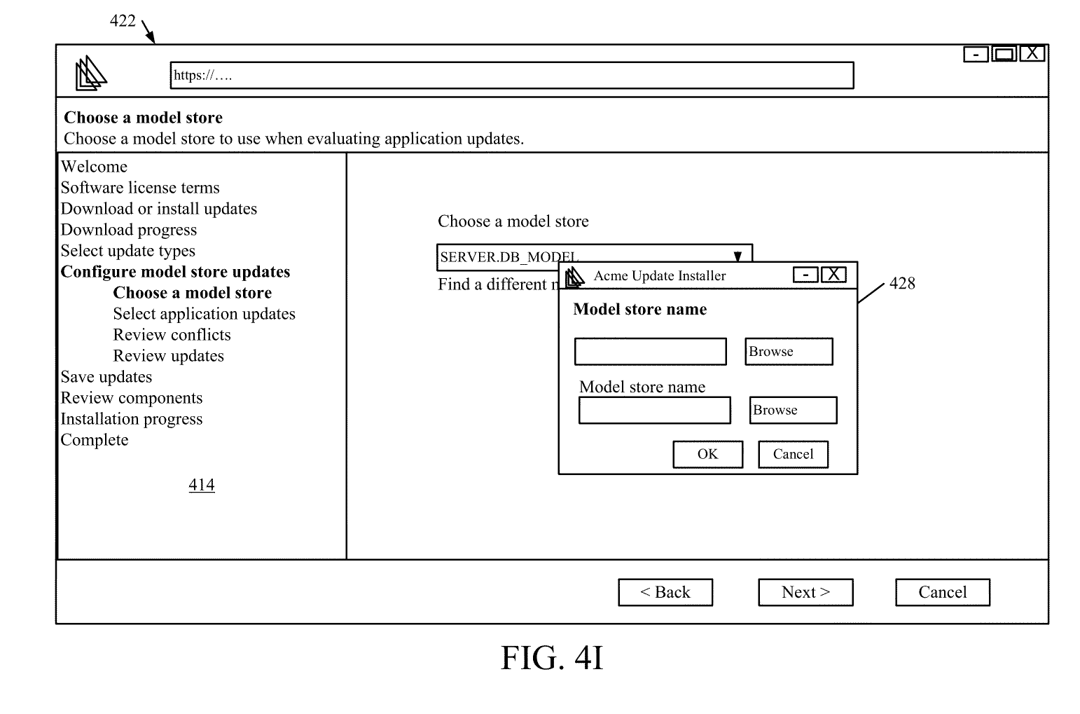

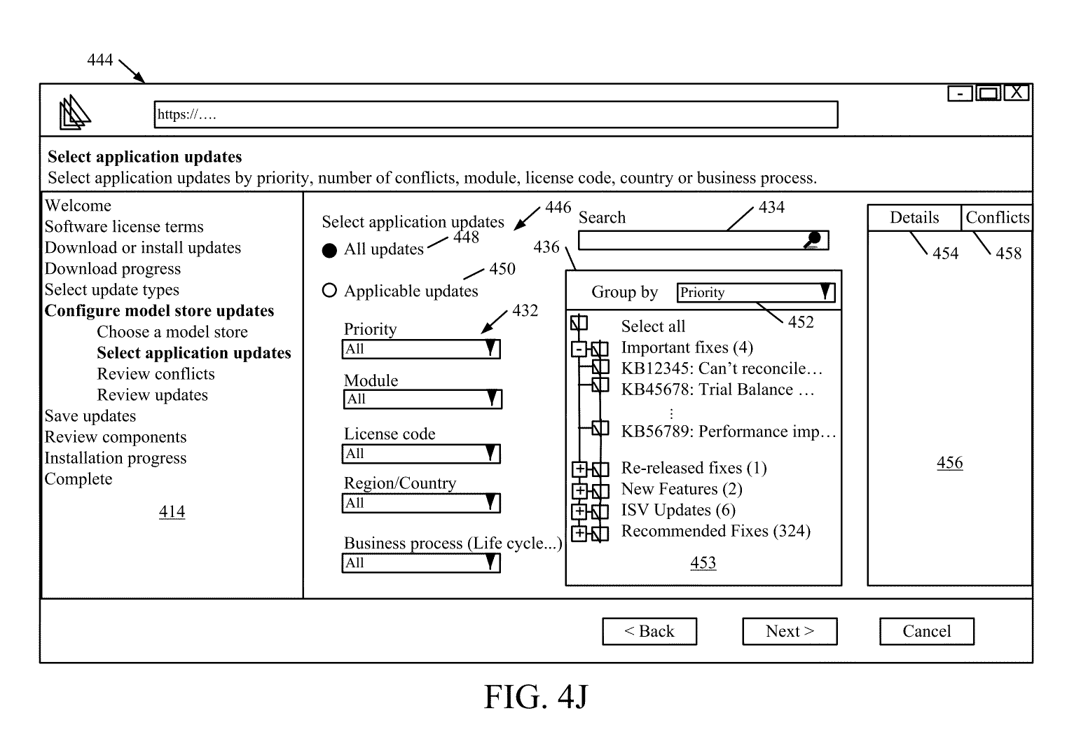

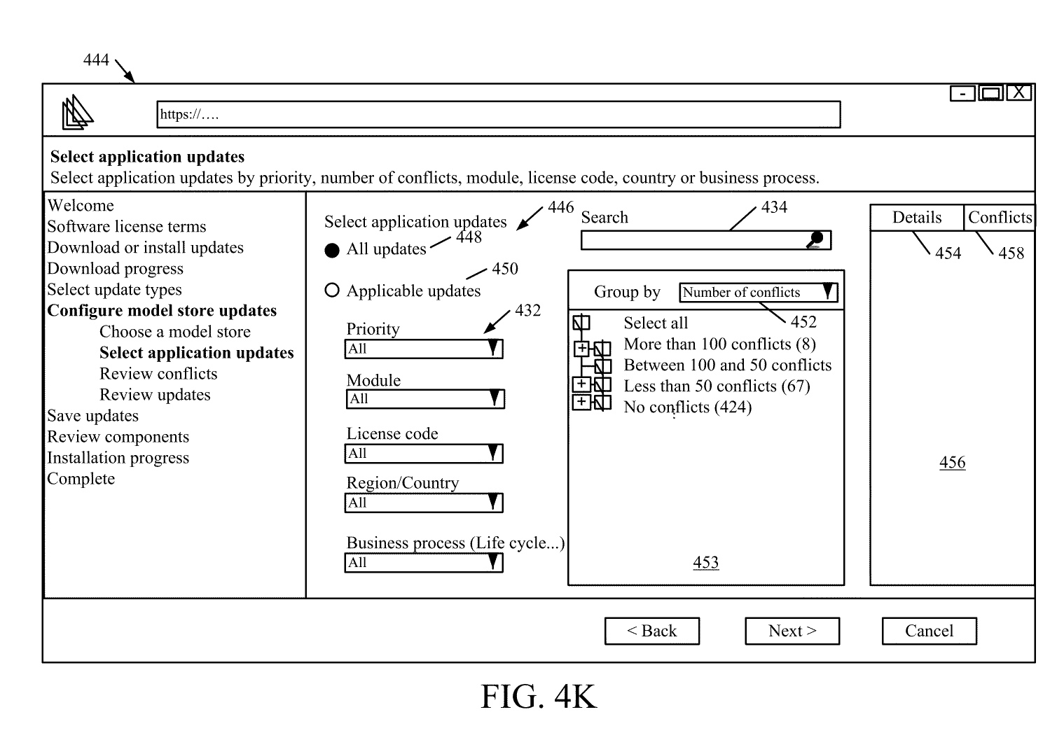

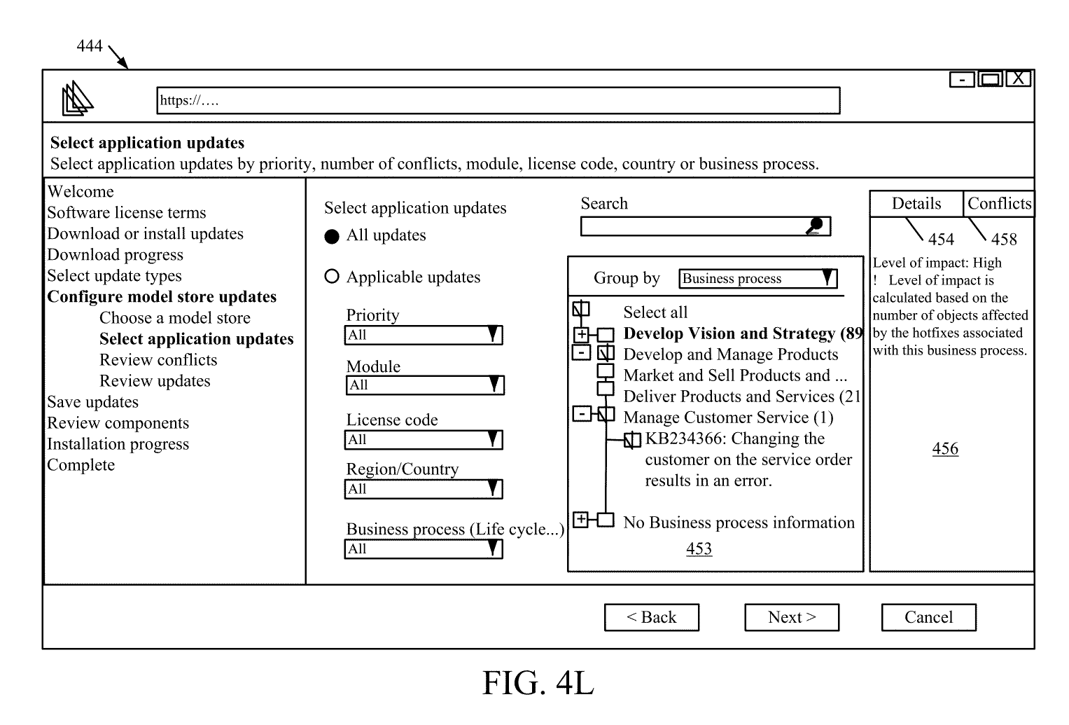

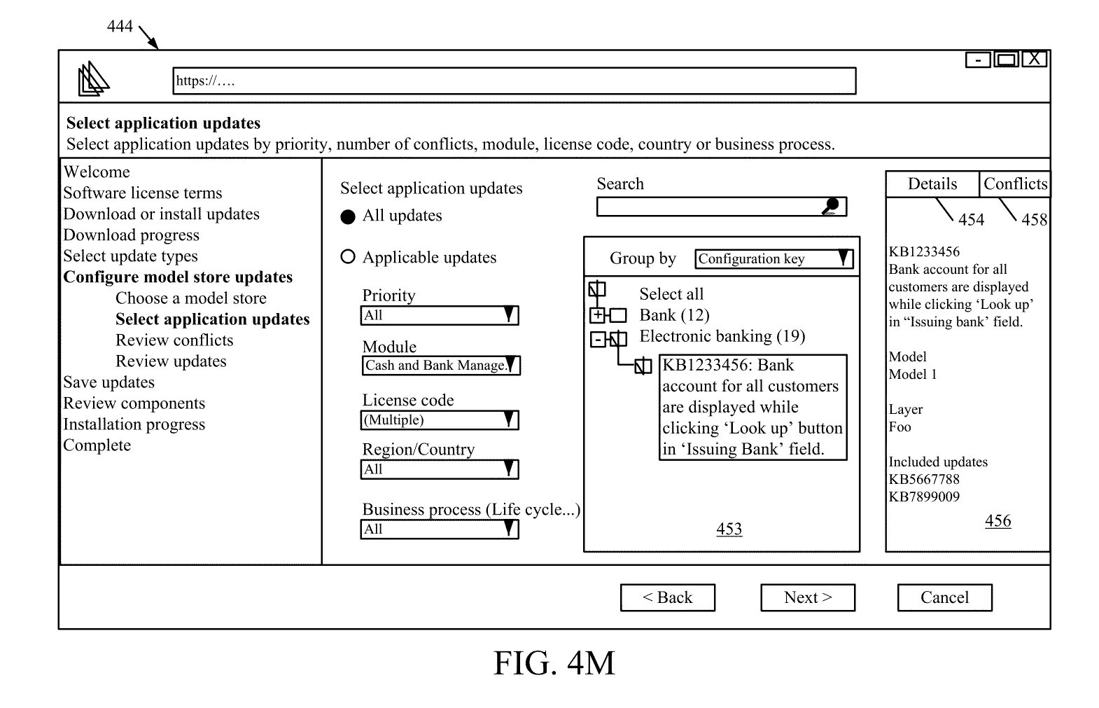

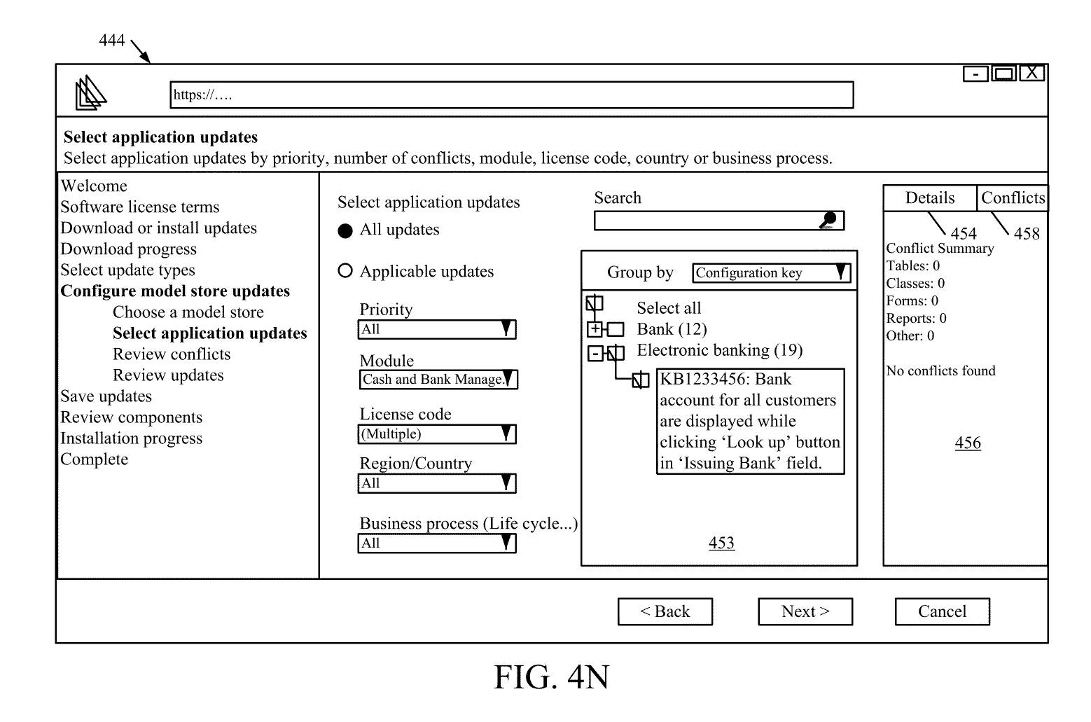

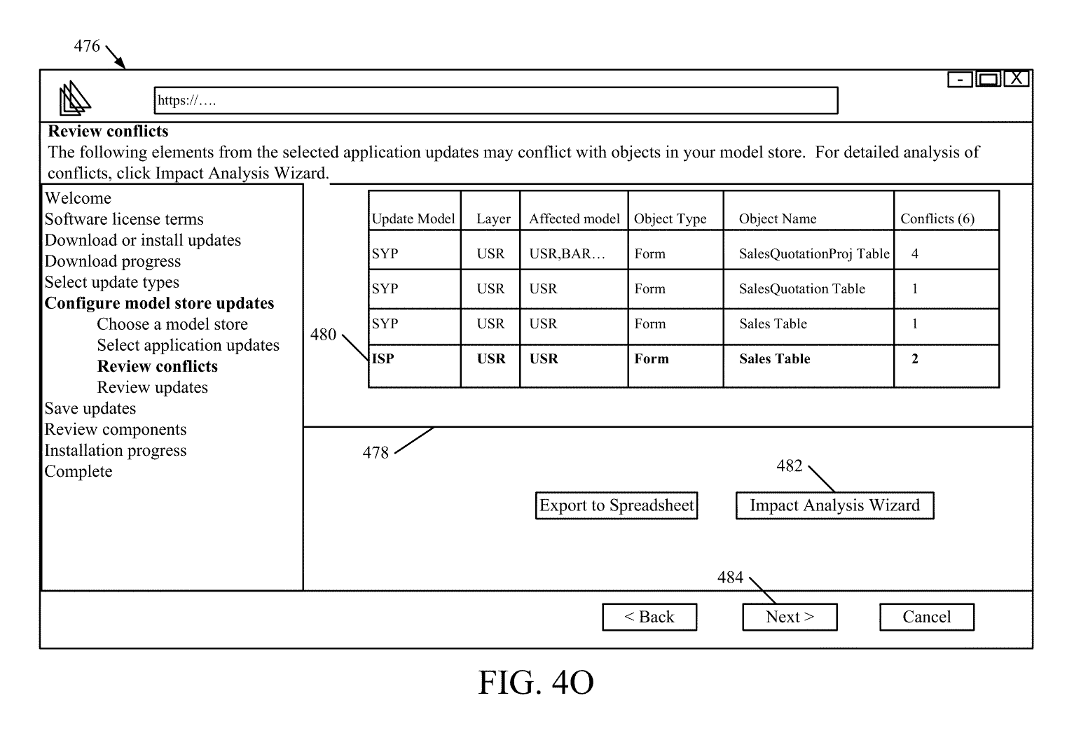

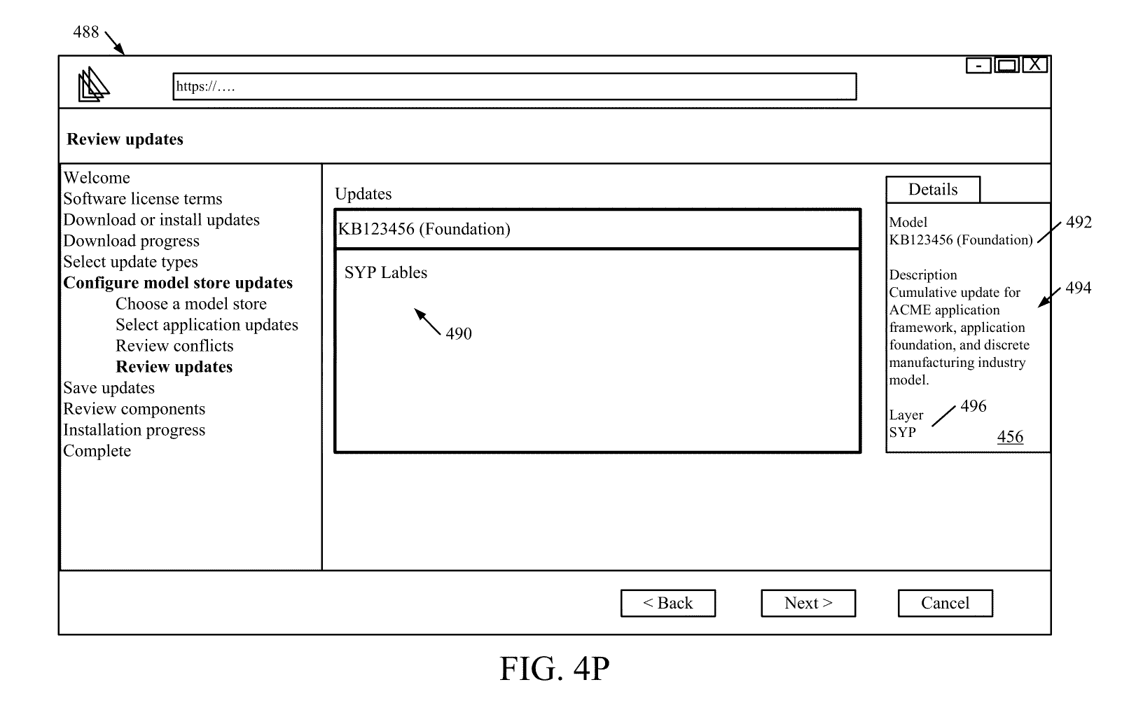

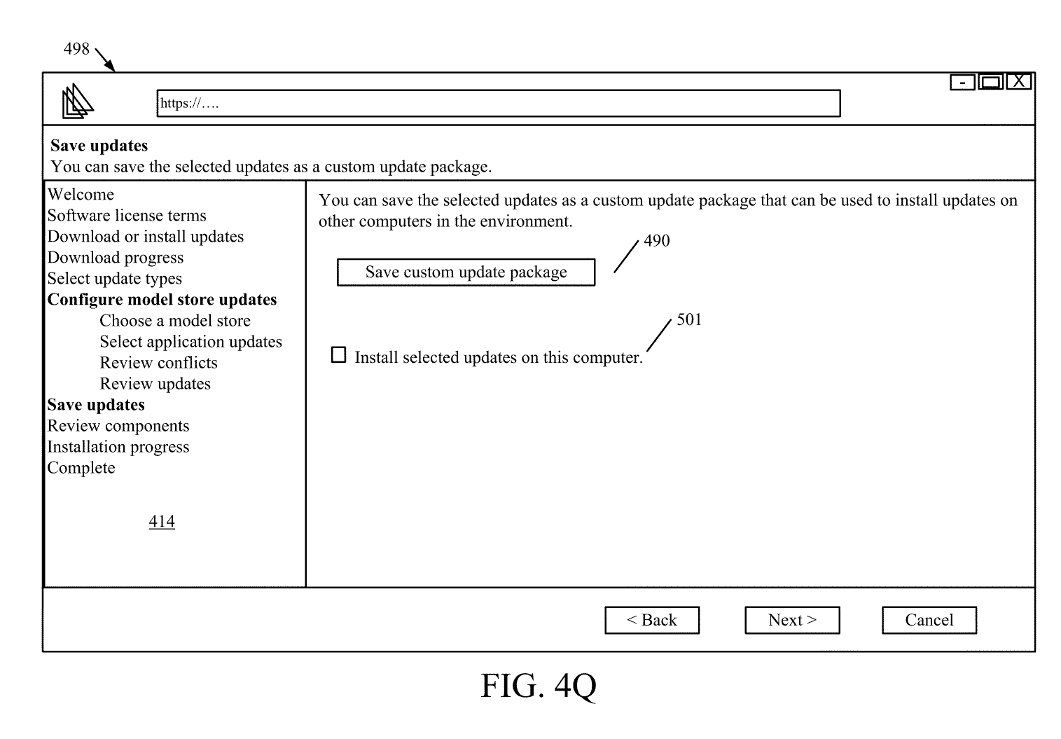

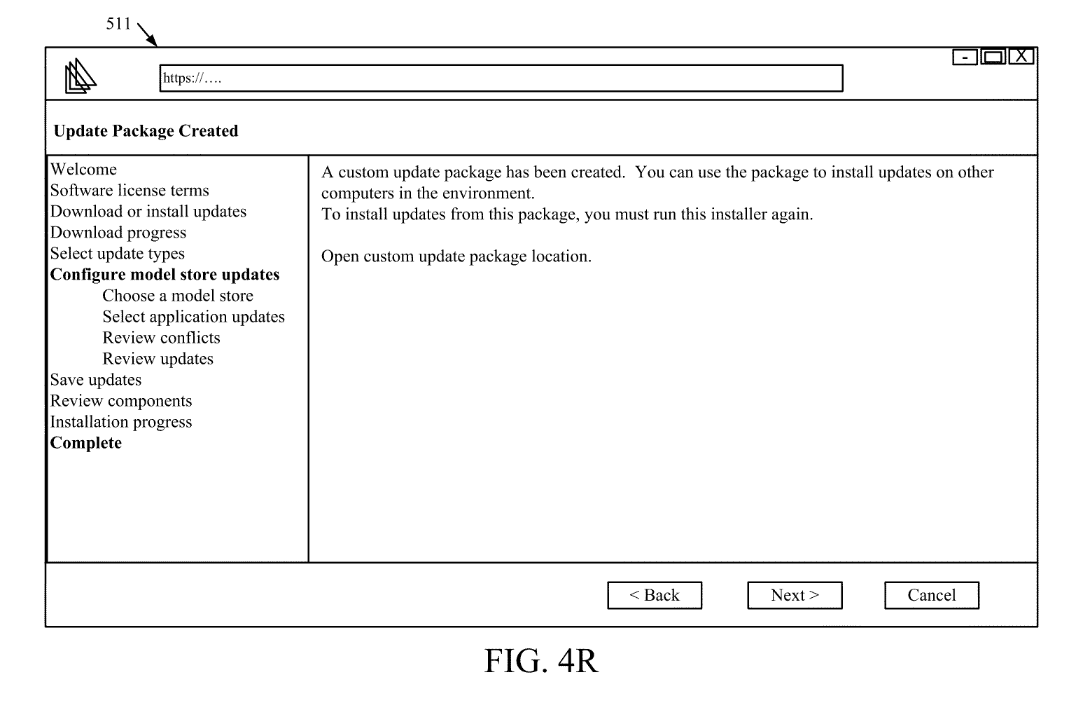

FIG. 2A shows one example of a block diagram of update installer component 154 in more detail. In the example shown, component 154 includes update selector 155, update evaluator 157, update downloader 159 and update installer 161. It can include other items 163 as well. Component 154 will be described in greater detail below with respect to FIGS. 4-4R. Briefly, however, selector 155 displays user input mechanisms that can be actuated to allow user 116 to select updates that can be evaluated against system 110, in terms of the impact that updates will have on the system. Evaluator 157 performs the evaluation of selected updates (including ISV updates 238) to show the impact they will have, such as in terms of conflicts they will generate, models, layers and processes they will affect, etc. Downloader 159 downloads selected updates (including ISV updates 238) and installer 161 installs them.

Before describing the overall operation of architecture 100 in more detail, a brief overview of its operation will be provided to enhance understanding. Cumulative updates 236 may intermittently become available to update the base system released by manufacturer 86. The cumulative updates 236 may include hot fixes or a variety of other updates as well, and they can be stored as available updates 228. In one example, update download component 128 can be used by ISV 108 to download selected updates that are available as available updates 228 in lifecycle system 120. The ISV 108 can then use code update functionality 130 in order to implement the updates on the version of the base system that was modified and released by ISV 108. Update certification component 136 can be used by ISV 108 to certify that the ISV updates are consistent with modification procedures, strategies, suggestions and guidelines of manufacturer 86. ISV 108 can then use update package generator 132 to generate an update package that contains the ISV updates. ISV 108 can then use update package upload component 134 to upload the ISV updates 238 to be stored as available updates 228 for the customer that is employing customer business system 110. At some point, the customer can use update installer component 154 to generate user interface displays that allow user 116 to select the various updates that are desired (including ISV updates 238) and to also see an impact analysis that indicates the impact (e.g., in terms of potential conflicts) of those updates on the user's business system 110. Update installer component 106 also illustratively allows the user to search for various updates based on subject matter or otherwise and to view the impact on the business processes 168, as well as to save selected updates for replay (or application) in other environments. Update installer component 154 also illustratively installs the selected updates and can automatically resolve at least some conflicts, when commanded to. The update state of the customer business system 110 is illustratively uploaded to lifecycle system 120 as update state tracking information 210.

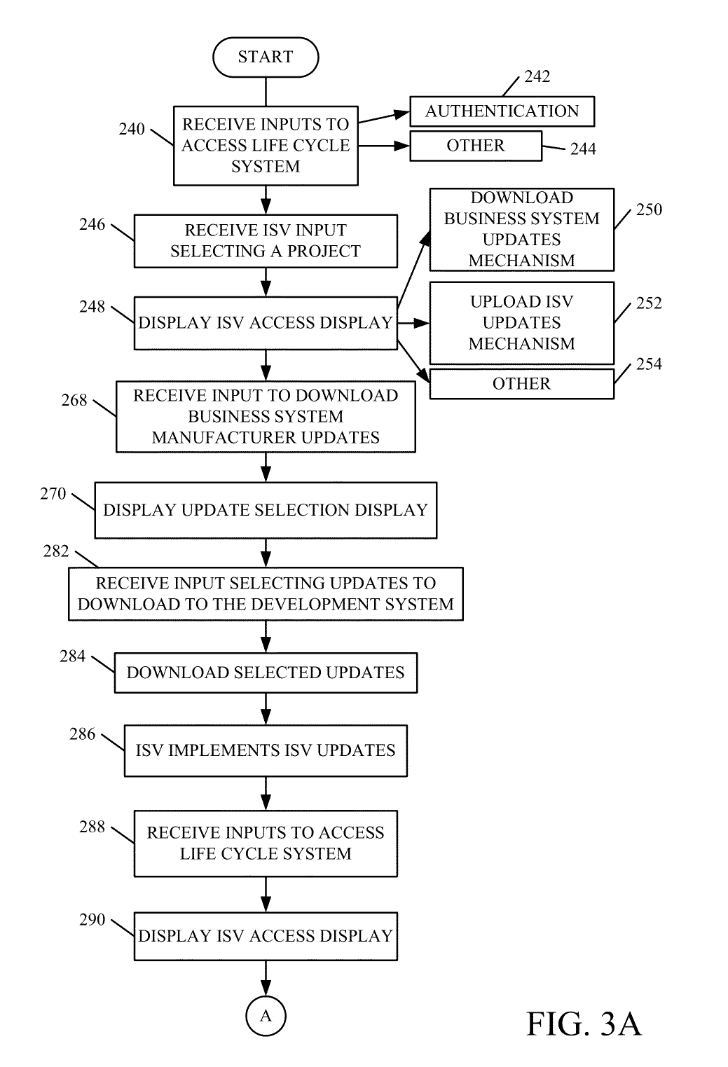

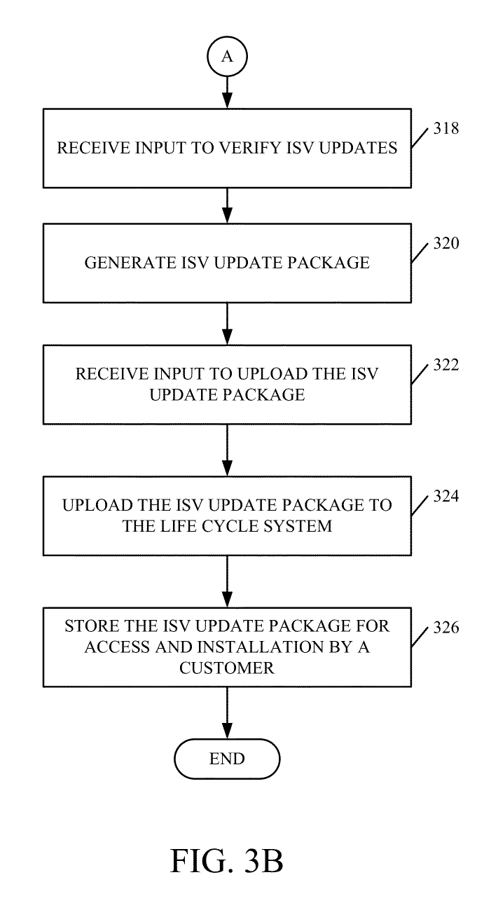

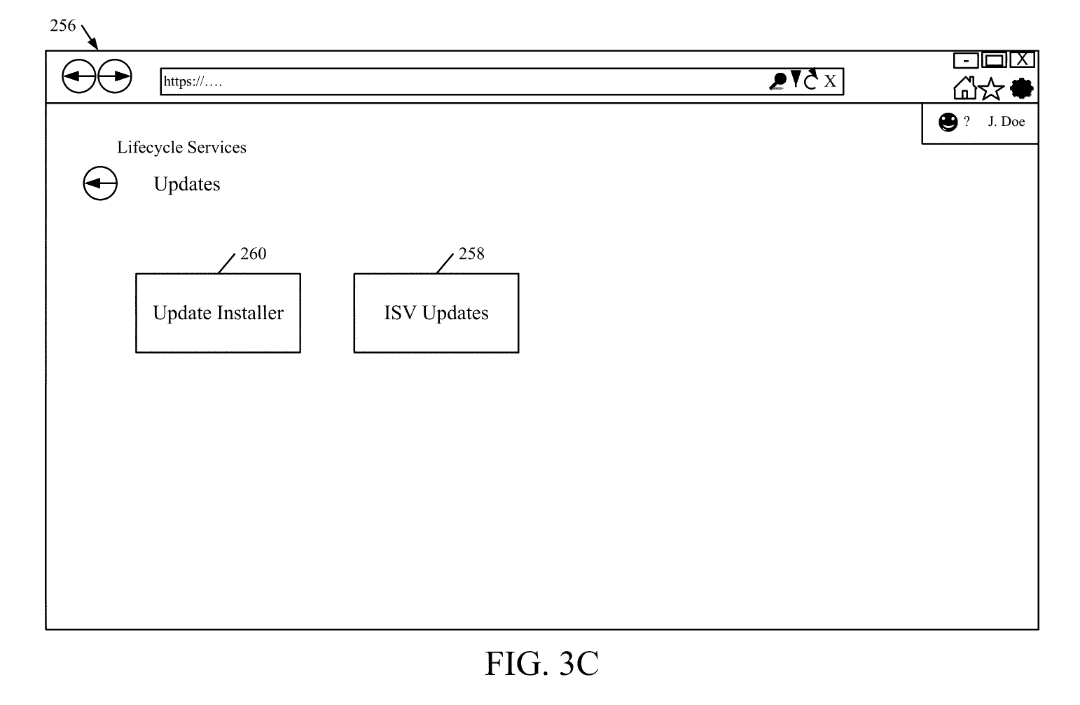

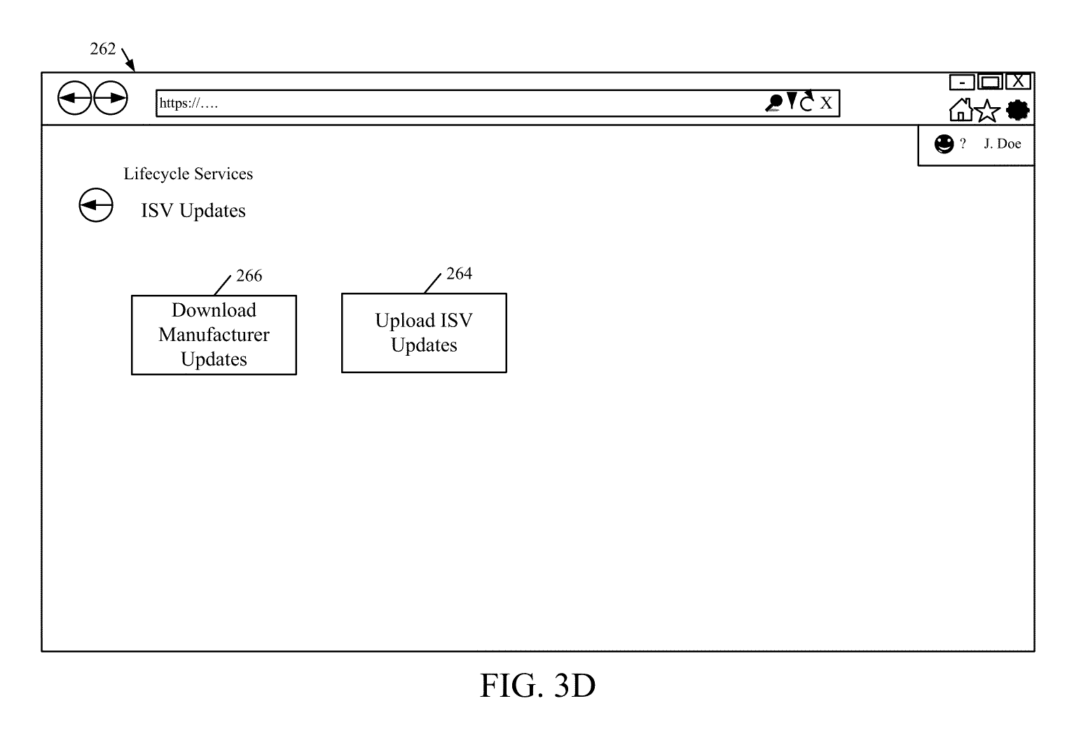

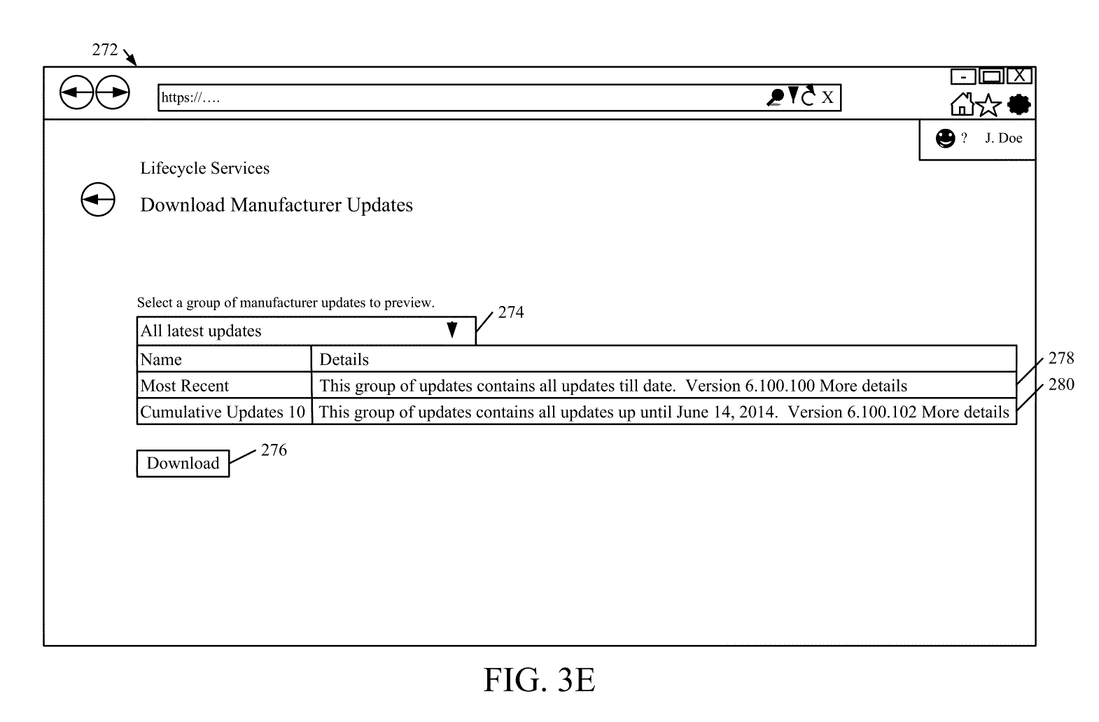

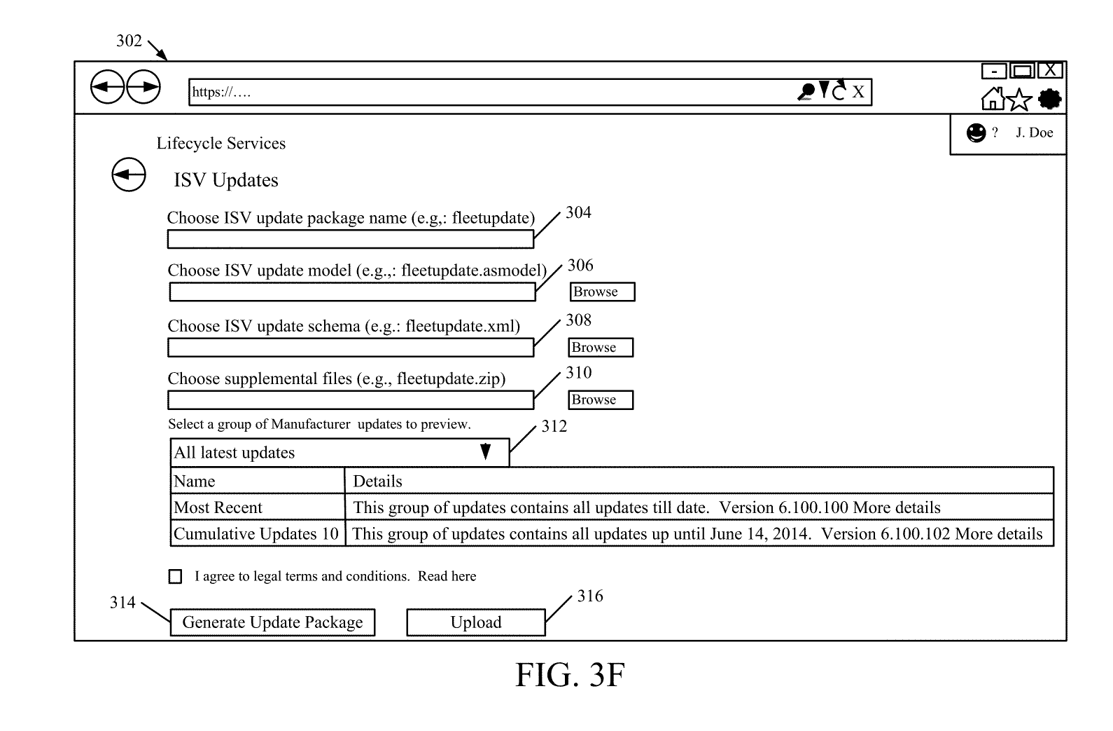

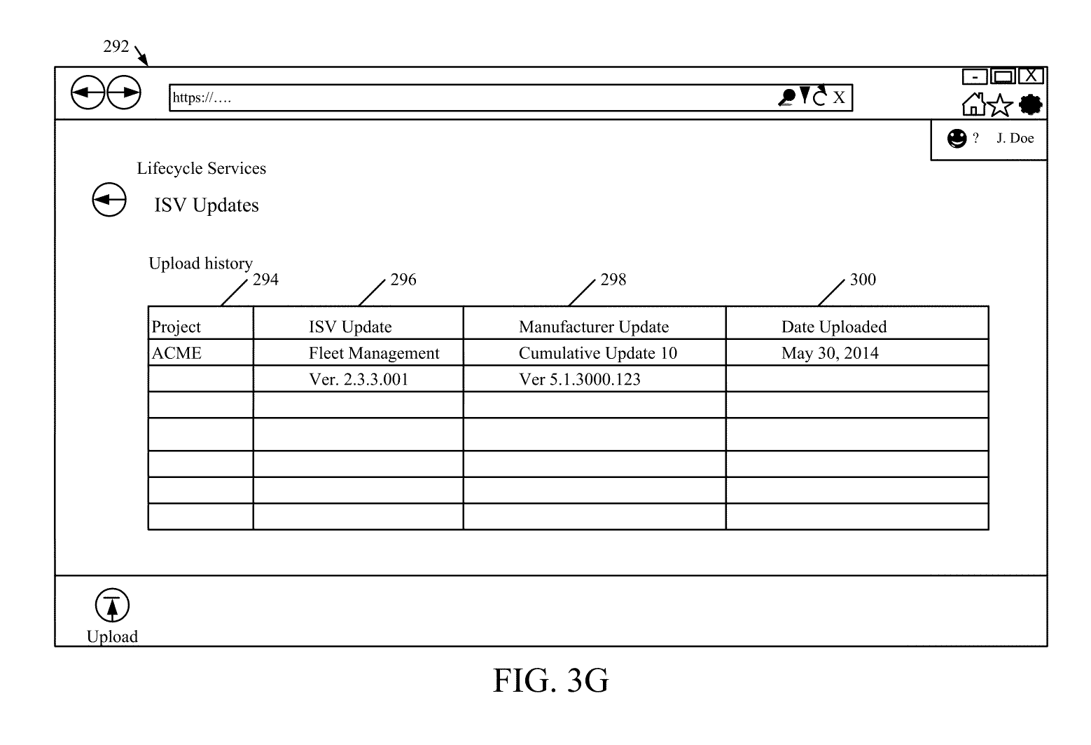

FIGS. 3A and 3B (collectively referred to as FIG. 3) show a flow diagram illustrating one example of how ISV 108 can use development system 102 and lifecycle system 120 to generate ISV updates on top of a cumulative update package (or other updates) released by manufacturer 86, and to make them available to the user of the ISV's system (e.g., to a developer or administrator of the deployed business system 110). FIGS. 3C-3G show various user interface displays that can be generated for ISV 108. FIGS. 3-3G will now be described in conjunction with one another.

Lifecycle system 120 first receives inputs from ISV 108 to access lifecycle system 120. This is indicated by block 240 in FIG. 3. By way of example, ISV 108 may provide authentication information 242 or other information 244.

ISV 108 then provides an input selecting one of the projects that ISV 108 has access to work on. This is indicated by block 246 in FIG. 3. Lifecycle system 120 then displays an ISV access display. This is indicated by block 248. In one example, the display includes a user input mechanism that allows ISV 108 to download updates. This is indicated by block 250. It can also include an input mechanism that can be actuated by ISV 108 to upload ISV updates to lifecycle system 120. This is indicated by block 252. It can, of course, include other user input mechanisms 254 as well.

FIG. 3C shows one example of a user interface display 256 that indicates this. It can be seen that the user has logged into lifecycle system 120 and ended up on an updates landing page. The page includes an ISV updates user input mechanism 258 that can be actuated by ISV 108 in order to be guided through a user experience for downloading ISV updates, uploading ISV updates, etc. The user input mechanism also illustratively includes a user input mechanism 260 that can be actuated in order to download an instance of an update installer component (such as the update installer component 154 discussed above).

When ISV 108 actuates user input mechanism 258, lifecycle system 120 illustratively generates a user interface display, such as display 262 shown in FIG. 3D. This provides a set of user input mechanisms 264 and 266 that allow ISV 108 to download manufacturer updates (by actuating mechanism 266) or to upload ISV updates to lifecycle system 120 (by actuating user input mechanism 264).

Referring again to the flow diagram of FIG. 3, it is first assumed that the ISV 108 actuates user input mechanism 266 to download business system manufacturer updates (such as a cumulative update package 236) from lifecycle system 120. Receiving this input is indicated by block 268 in the flow diagram of FIG. 3.

Lifecycle system 120 then generates an update selection display that allows ISV 108 to select which particular updates that ISV 108 wishes to download. Displaying the update selection display is indicated by block 270 in FIG. 3.

FIG. 3E shows one example of a user interface display 272 that illustrates this. It can be seen that display 272 includes a selection user input mechanism 274 and a download mechanism 276. When ISV 108 actuates mechanism 274, lifecycle system 120 illustratively displays all of the manufacturer updates that are available in lifecycle system 120 for ISV 108. In the example shown in FIG. 3E, a first set of updates is illustrated by mechanism 278. This corresponds to all updates made until the present date. A second mechanism 280 corresponds to the most recent cumulative update package that has been released. ISV 108 can illustratively select one or more of the available updates by actuating one of mechanisms 278 and 280, and then download those updates to development system 102 by actuating download mechanism 276. Receiving inputs selecting the updates to download to development system 102, and downloading the selected updates are indicated by blocks 282 and 284, respectively, in the flow diagram of FIG. 3.

Once ISV 108 has downloaded the updates to development system 102, ISV 108 illustratively uses code update functionality 130 to make updates to the various entities, applications, business processes, workflows, etc. so that the ISV updates can be made available to users of customer business system 110. Providing inputs to implement the ISV updates is indicated by block 286 in the flow diagram of FIG. 3.

Once the ISV has completed making the ISV updates, ISV 108 can again access lifecycle system 120. Receiving inputs to access the lifecycle system is indicated by block 288 in the flow diagram of FIG. 3. Lifecycle system 120 then again displays the ISV access display as indicated by block 290. This was described above with respect to FIG. 3D. In this case, however, ISV 108 actuates the upload ISV updates user input mechanism 264. Lifecycle system 120 then allows ISV 108 to verify the ISV updates and to generate an update package that includes the ISV updates.

By way of example, FIG. 3G shows a user interface display 292. User interface display 292 allows the ISV 108 to view the upload history for various ISV updates. The upload history illustratively includes a project identifier 294 that identifies a project, an ISV update identifier 296 that identifies the ISV update, a manufacturer update identifier 298 that identifies the cumulate update package (or other manufacturer updates) that were used as the basis for these ISV updates, and a date uploaded identifier 300 that identifies the dates the updates were uploaded.

For instance, FIG. 3F shows one example of a user interface display 302 that can be generated by lifecycle system 120 in order to allow ISV 108 to generate an update package and to upload the update package as ISV updates 238, to lifecycle system 120. It can be seen that display 302 illustratively includes an ISV package name mechanism 304 that allows the ISV 108 to specify a package name. It includes an ISV update model identifier 306 that can be used by ISV 108 to identify an ISV update model that the update applies to. It can include an update schema mechanism 308 that allows ISV 108 to specify an ISV update schema for the update package, and it can include a supplemental files mechanism 310 that can be used by ISV 108 to identify supplemental files that are to be included with the update package. It also includes a manufacturer update mechanism 312 that can be used by ISV 108 to identify the particular set of manufacturer updates that form the basis of the present ISV update package.

User interface display 302 also illustratively includes a generate update package user input mechanism 314 and an upload user input mechanism 316. When ISV 108 actuates mechanism 314, update package generator 132 (which can be located in development system 102 or in lifecycle system 120) illustratively generates an update package for being uploaded to lifecycle system 120. When ISV 108 actuates upload mechanism 316, update package upload component 134 uploads the ISV update package, as ISV updates 238, to lifecycle system 120, where they can be accessed by users or developers of customer business system 110.

Referring again to the flow diagram of FIG. 3, receiving an input to verify the ISV updates is indicated by block 318. Generating the ISV update package is indicated by block 320. Receiving an input to upload the ISV update package to lifecycle system 120, and uploading the ISV update package is indicated by blocks 322 and 324, respectively. Lifecycle system 120 then stores the ISV updates 238 for access and installation by a customer or developer in a customer business system 110. This is indicated by block 326.

FIGS. 4A and 4B (collectively referred to as FIG. 4) show flow diagram illustrating one example of the operation of lifecycle system 120 in allowing user 116 to download and install updates, including ISV updates 238, to customer business system 110. FIGS. 4C-4R are examples of user interface displays that can allow user 116 to do this. FIGS. 4-4R are now described in conjunction with one another.

User 116 first illustratively provides inputs to business system 110 (or directly to lifecycle system 120) to access available updates. This is indicated by block 328 in FIG. 4.

System 110 then launches update installer 154. This is indicated by block 330. Update installer 154 can illustratively generate displays of a variety of preliminary screens, as indicated by block 332. For instance, update installer 154 can generate a welcome display 334, it can display a license terms acceptance page 336 and a variety of other preliminary display screens 338.

Update installer component 154 then displays user input mechanisms that allow user 116 to select downloading or installing updates. This is indicated by block 340. FIG. 4C shows one example of a user interface display 342 that indicates this. It can be seen that display 342 illustratively includes a navigation pane 344 that includes a list of actuatable user input mechanisms 346 that can be actuated by user 116 in order to navigate to a certain portion of the download or install process. In an alternate example, pane 344 simply contains a list of different phases of the process, and it highlights the particular phase that the user is in so that the user has an indication of what has been done, and what is left.

In any case, display 342 also includes user input mechanisms 348 and 350. User input mechanism 348 can be actuated by user 116 in order to download updates. Mechanism 350 can be actuated by user 116 in order to install previously downloaded updates as briefly discussed above. In the example shown in FIG. 4C, the user has actuated mechanism 348 in order to download updates.

If the user actuates user input mechanism 350, then the user is navigated through a user experience that allows the user to install updates that have been previously downloaded from lifecycle system 120. This is indicated by blocks 352 and 354 in the flow diagram of FIG. 4. By way of example, the install process can allow the user to view updates as indicated by block 356, to see an impact or conflict analysis relative to selected updates as indicated by block 358, to select individual or groups of updates as indicated by block 360, to apply the updates to the customer system as indicated by block 362, to automatically or manually resolve conflicts generated by the updates, as indicated by block 364, and to perform other install processing as indicated by block 366. This can all be done with respect to any available updates 228, including the ISV updates 238.

However, for the present example, it is assumed that the user has actuated mechanism 348 to download available updates 228 from lifecycle system 120. In that case, update installer component 154 illustratively generates user interface displays that allow user 116 to access lifecycle system 120. This is indicated by block 368 in FIG. 4.

FIG. 4D shows one example of a user interface display 370 that indicates this. It can be seen in display 370 that the user can log in as a customer, a partner, or a manufacturer employee. These are examples only. Once the user has logged into lifecycle system 120, system 120 illustratively generates displays for selecting updates and a project against which the updates are to be evaluated. This is indicated by block 372 in FIG. 4.

FIG. 4E shows one example of a user interface display 374 that indicates this. It can be seen that display 374 includes an update selection user input mechanism 376 that allows user 116 to select a set of updates for being evaluated. It includes the two sets of manufacturer updates that were described above with respect to FIG. 3E. However, it also includes a user input mechanism 378 that can be actuated to select the ISV updates 238 that were previously uploaded to lifecycle system 120 by ISV 108.

Display 374 also includes a project selection mechanism 380 that can be actuated by user 116 to select a project against which the selected updates are to be evaluated. Receiving inputs selecting a project and updates for evaluation is indicated by block 382 in the flow diagram of FIG. 4. Lifecycle system 120 then illustratively accesses environmental information 182 to obtain an indication of the set of business processes 184 that are deployed in customer business system 110. Obtaining the business process information for the selected project is indicated by block 384 in FIG. 4. It then generates a user interface display that allows user 116 to select whether the user wishes to apply ISV application updates or other updates. This is indicated by block 386. The ISV application updates are indicated by block 388 and the other updates are indicated by block 390.

FIG. 4F shows one example of a user interface display 392 that indicates this. It can be seen in FIG. 4F that the user is selecting both binary updates and ISV application updates because the user has selected both user input mechanisms 394 and 396. Receiving user inputs selecting the update type is indicated by block 398 in FIG. 4.

Lifecycle system 120 can then illustratively generate a user interface display that asks user 116 to again accept the ISV license terms. This is indicated by block 400 in FIG. 4. FIG. 4G shows one example of a user interface display 402 that indicates this. The user can accept the license terms and continue by actuating user input mechanism 416.

Lifecycle system 120 (either itself or under the control of update installer component 154) then navigates the user 116 through a user experience by which user 116 can configure the model store for the selected updates. Generating these displays and receiving user inputs selecting a model store is indicated by block 418 and 420 in FIG. 4. FIG. 4H shows one example of a user interface display 422 that allows the user to do this. It can be seen in FIG. 4H that display 422 includes a user input mechanism 424 that allows the user to select or find a model store to use when evaluating the selected application updates. FIG. 4I shows user interface display 422, except that the user has actuated user input mechanism 426 (in FIG. 4H) to find another model store. Thus, user input mechanism 428 is generated that allows the user to browse the system for various model stores.

Once user 116 has selected a model store, lifecycle system 120 (either by itself or through update installer component 154) then generates a set of user interface displays that allow user 116 to select the application updates for evaluation. This is indicated by block 430 in FIG. 4. In one example, the user interface display includes user input mechanisms that allow user 116 to filter the selected updates by actuating various filter mechanisms 432. For instance, the user can illustratively filter the updates based on priority, module, license code, region, business process, etc. User input mechanisms can also include a search mechanism 434 that allows the user to search for certain updates, a grouping mechanism 436 that allows the user to group updates, a details display pane 438 that allows the user to view details corresponding to selected updates, and a conflicts pane 440 that allows the user to view conflicts that will be generated by the selected updates. The display for selecting updates for evaluation can include other items 442 as well.

FIGS. 4J-4N show examples of user interface displays indicating this. It can be seen in FIG. 4J that user interface display 444 illustratively includes a set of filter mechanisms 446. As briefly discussed above, the user can select all updates or only applicable updates to the user's system by actuating mechanisms 448 and 450. The user can also actuate any of the set of mechanisms 432 to filter the updates based on priority, module, license code, region/country, business process, etc. Display 444 also shows the search user input mechanism 434 that can be used by user 116 to search for a selected update using keyword searching. It shows grouping mechanism 436 by which the user can group the selected updates based on a set of grouping criteria that can be selected using mechanism 452. It can be seen in FIG. 4J that the user has selected to group the selected updates based on priority. Details tab 454 allows the user to see details about the selected updates in pane 456. Conflicts tab 458 can be actuated by the user to see conflicts caused by the selected updates in pane 456.

FIG. 4K shows user interface display 444, and similar items are similarly numbered. However, it can be seen that the user has selected, using grouping mechanism 452, to group the selected updates by the number of conflicts. Therefore, that information is displayed in pane 453.

FIG. 4L is similar to FIG. 4K, and similar items are similarly numbered. However, it can be seen in FIG. 4L that the user has elected to group the selected updates by business process. Therefore, the business process information corresponding to the updates is displayed in pane 453. Also, details are now displayed in pane 456.

FIG. 4M is similar to FIG. 4L, and similar items are similarly numbered. However, it can be seen in FIG. 4M that the user has decided to group the selected updates by configuration key. Also, the user has elected to filter the updates by module by inserting the “cash and bank management” model identifier in the module filter mechanism. The user has also elected to filter the updates by license code by indicating “multiple” in that filter mechanism. Again, details tab 454 has been actuated to show details in pane 456.

FIG. 4N is similar to FIG. 4M, and similar items are similarly numbered. However, it can be seen in FIG. 4N that the user has now actuated conflicts tab 458. Therefore, conflict information corresponding to the selected updates is now displayed in pane 456. Receiving inputs selecting updates for evaluation is indicated by block 460 in the flow diagram of FIG. 4.

An impact analyzer either in update installer component 154 or lifecycle system 120 then performs an impact analysis that identifies the impact of the selected conflicts on the user's system. Performing this type of evaluation is indicated by block 462. The impact analysis can include a conflict analysis 464 where conflicts will be identified. It can also be an additional impact analysis 466 which will identify the full impact of the selected updates (in terms of the number of objects in the customer's system) that will be impacted by the selected updates. It can include other analyses 468 as well.

The user can then elect to view the conflict information obtained through the analysis. Displaying the conflict analysis results including conflicts created by the ISV updates is indicated by block 470 in FIG. 4. The conflict analysis results can illustratively be displayed with the user input mechanism to see the detailed impact of the selected updates and conflicts. This is indicated by block 472. Of course, it can include other information 474 as well.

FIG. 4O shows one example of a user interface display 476 that illustrates this. It can be seen that display 476 now displays the results of the conflict analysis in pane 478. It displays the elements from the selected application updates that may conflict with objects in the customer's model store. It should be noted that the list of models includes ISV models (such as the ISV model illustrated by entry 480) in pane 478. Thus, the system not only shows the conflicts that will be generated by the manufacturer updates, but also those that will be generated by updates in the ISV update package that was uploaded by ISV 108. Should the user wish to see a more detailed analysis of the conflicts, the user can illustratively actuate impact analysis wizard mechanism 482. This can cause the update installer 154 to perform a more detailed analysis for review by the user.

The user can also review the selected updates by actuating the next button 484. Displaying review of selected updates is indicated by block 486 in FIG. 4. FIG. 4P shows one example of a user interface display 488 that illustrates this. It can be seen that the selected updates are listed generally at 490. The details pane 456 now displays details corresponding to the selected updates. For instance, it includes an update identifier 492, an update description 494, and the layer that is affected by the update at 496.

The user can then elect to save or install the selected updates. This is indicated by block 497 in the flow diagram of FIG. 4. FIG. 4Q shows one example of a user interface display 498 that illustrates this. It can be seen that the user can select one of the mechanisms 499 or 501 to either save the selected updates as a custom update package, or to install the updates on the user's system, respectively. If the user elects to install the updates, update installer component 154 will install the updates, and display installation results (such as code merge results, conflict results, etc.) for the user 116. If the user elects to save the update package, then that is displayed as well. Saving or installing the updates is indicated by block 503 in FIG. 4. Saving the updates as a customer update package is indicated by block 505, navigating the user through installation and conflict resolution processes for installing the updates is indicated by block 507, and other processing is indicated by block 509.

FIG. 4R shows one example of a user interface display 511 that is an example of a final display that can be displayed when the user has elected to save the update package instead of installing. If the user wishes to later install the package, the user can launch update installer component 154, select the custom update package for installation, and install the package, even across multiple different machines in multiple different environments.

It can thus be seen that the present system greatly reduces ISV maintenance cost in keeping up with the continuous release of cumulative manufacturer updates. It allows the ISV to preview manufacturer updates, upload ISV updates and release the ISV updates along with the manufacturer updates. It also makes delivery of ISV updates much quicker and less error prone, because they are delivered in the same way that manufacturer updates are delivered. Update installation in this way improves the performance of the ISV's system in that the ISV updates are delivered more quickly with fewer errors. It improves the performance of the customer system, because the customer system can be updated more quickly and more accurately. It also greatly improves the efficiency of both the ISV and the users of the customer system. In addition, it allows the user to download cloud-sourced ISV updates at any time, to filter those updates based on metadata, to perform impact analysis for ISV updates to be applied on a local level, and to create custom update packages from both the manufacturer updates and ISV updates through the update installer. It also allows the user to apply custom update packages that contain both the manufacturer updates and the ISV updates across multiple machines and environments. The user can also automatically merge code conflicts resulting from development of the ISV updates.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

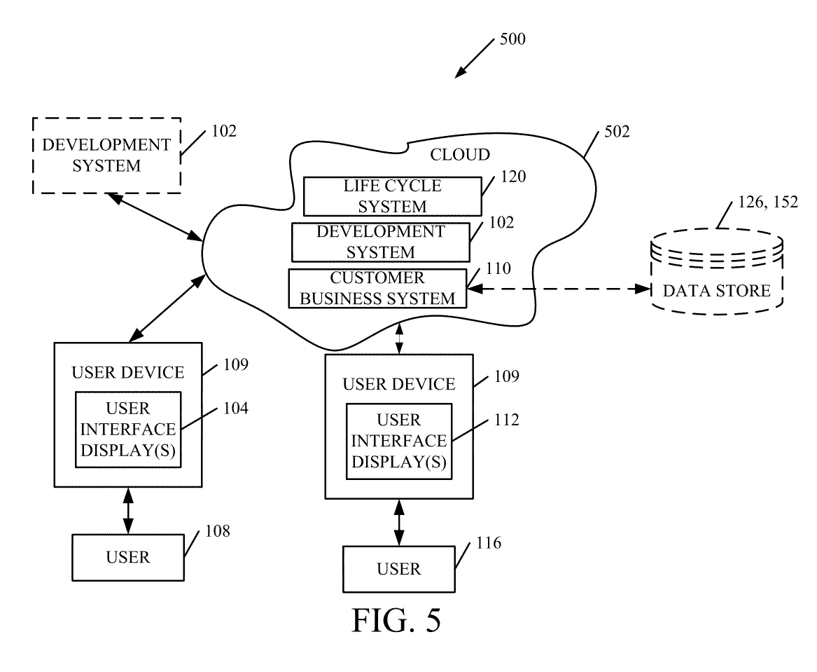

FIG. 5 is a block diagram of architecture 100, shown in FIG. 2, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 5, some items are similar to those shown in FIG. 2 and they are similarly numbered. FIG. 5 specifically shows that systems 102, 110 and 120 can be located in cloud 502 (which can be public, private, or a combination where portions are public while others are private). Therefore, ISV 108 and user 116 can use user devices 109 to access those systems through cloud 502.

FIG. 5 also depicts another example of a cloud architecture. FIG. 5 shows that it is also contemplated that some elements of architecture 100 can be disposed in cloud 502 while others are not. By way of example, data stores 126, 152 can be disposed outside of cloud 502, and accessed through cloud 502. In another example, development system 102 (or other systems) can also be outside of cloud 502. Regardless of where they are located, they can be accessed directly by devices 109, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

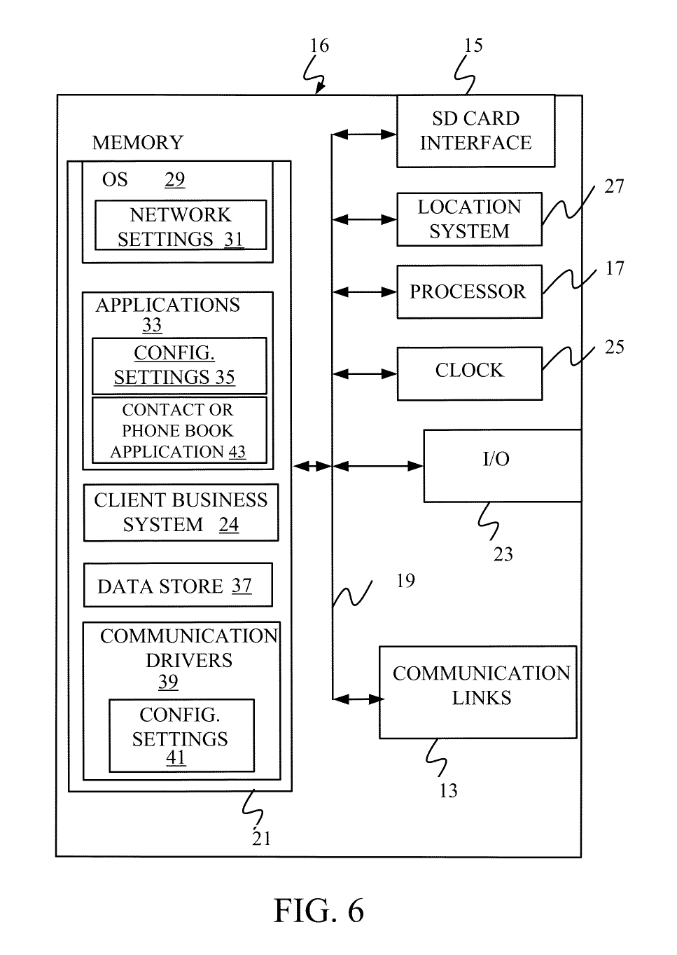

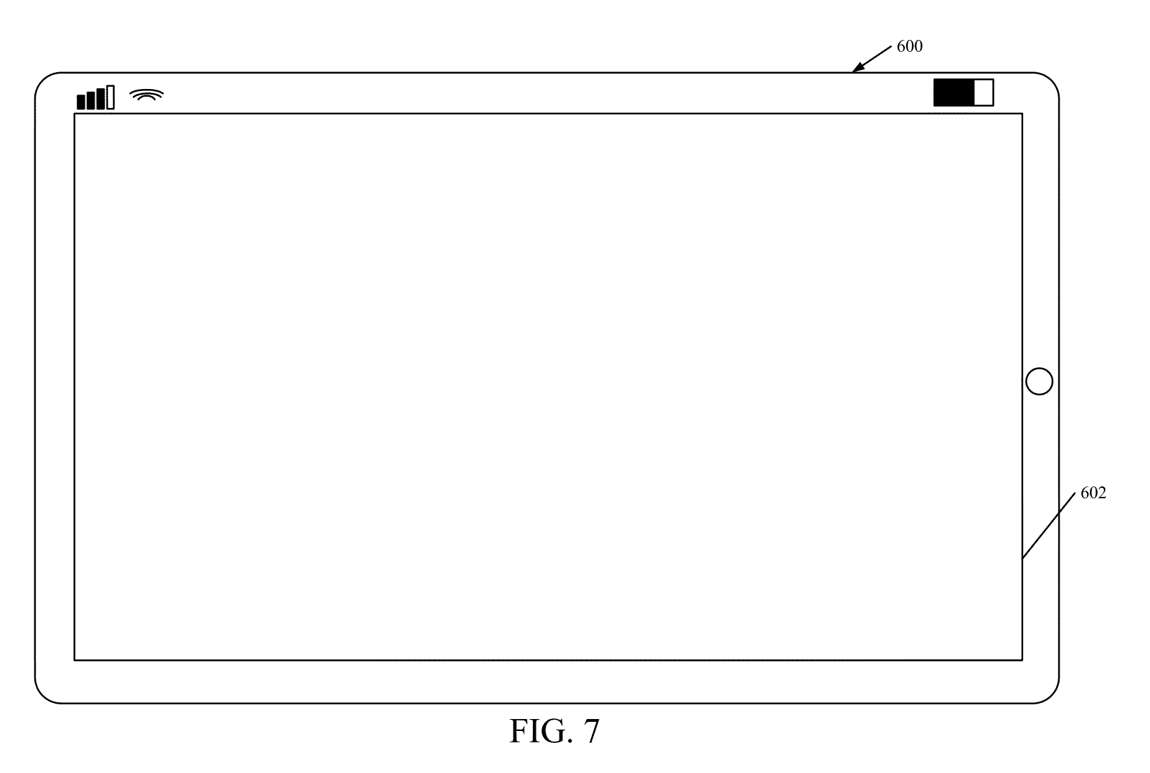

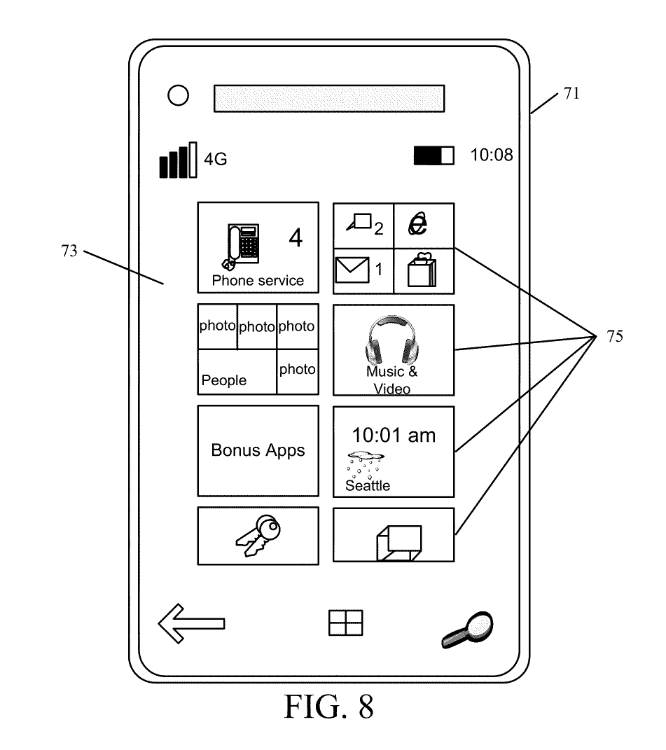

FIG. 6 is a simplified block diagram of one illustrative embodiment of a handheld or mobile computing device that can be used as a user's or client's hand held device 16, in which the present system (or parts of it) can be deployed. FIGS. 7-8 are examples of handheld or mobile devices.

FIG. 6 provides a general block diagram of the components of a client device 16 that can run components of architecture 100 or that interacts with architecture 100, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as Wi-Fi protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processors 122, 150, 226 from FIG. 2) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client business system 24 which can run various business applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one embodiment in which device 16 is a tablet computer 600. In FIG. 7, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 that can be used as well. Device 16 can be a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1×rtt, and Short Message Service (SMS) signals. In some examples, the phone can also includes a Secure Digital (SD) card slot that accepts a SD card.

The mobile device can also be a personal digital assistant (PDA) or a multimedia player or a tablet computing device, etc. (hereinafter referred to as PDA). The PDA can includes an inductive screen that senses the position of a stylus (or other pointers, such as a user's finger) when the stylus is positioned over the screen. This allows the user to select, highlight, and move items on the screen as well as draw and write. The PDA can also include a number of user input keys or buttons which allow the user to scroll through menu options or other display options which are displayed on the display, and allow the user to change applications or select user input functions, without contacting the display. The PDA can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

FIG. 8 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

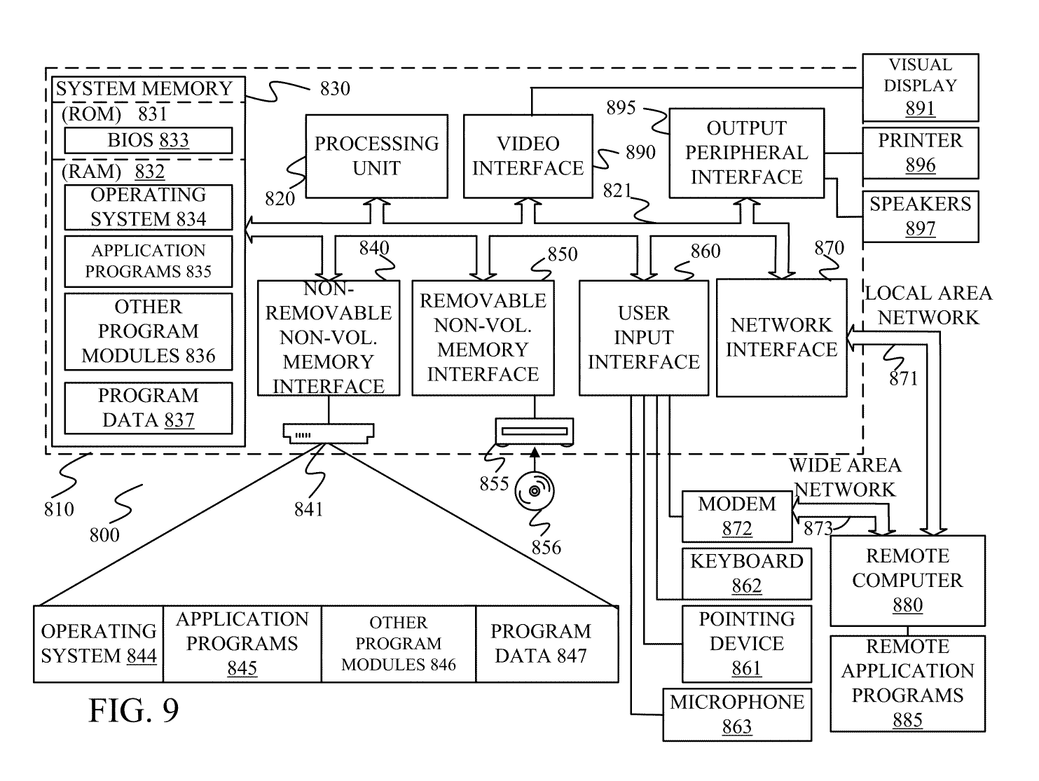

FIG. 9 is one example of a computing environment in which architecture 100, or parts of it, (for example) can be deployed. With reference to FIG. 9, an example system for implementing some embodiments includes a general-purpose computing device in the form of a computer 810. Components of computer 810 may include, but are not limited to, a processing unit 820 (which can comprise processors 122, 150 or 226), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 2 can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 9 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 9 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

an update download component that displays a download user input mechanism that is actuated to access, at a remote server system, manufacturer updates to a base system and, in response to actuation of the download user input mechanism, downloads the manufacturer updates for implementation, through intermediate developer updates, at an intermediate developer system;

an update functionality component that displays update user input mechanisms and, in response to actuation of the update user input mechanisms, generates the intermediate developer updates, based on the manufacturer updates; and

an update upload component that displays an upload user input mechanism and that, in response to actuation of the upload user input mechanism, uploads the intermediate developer updates, that implement the downloaded manufacturer updates, to the remote server system for access and installation at an end user system.

Example 2 is the computing system of any or all previous examples wherein the base system comprises a base business system and wherein the manufacturer updates comprise manufacturer updates to the base business system.

Example 3 is the computing system of any or all previous examples and further comprising:

an update package generator that displays a package generation user input mechanism and generates an update package including the intermediate developer updates and the downloaded manufacturer updates.

Example 4 is the computing system of any or all previous examples wherein the package generation user input mechanisms include a name input mechanism actuated to name the update package, a model input mechanism actuated to identify an update model corresponding to the update package and a related update mechanism that is actuated to identify the manufacturer updates that are related to the update package.

Example 5 is the computing system of any or all previous examples wherein the update upload component displays a package selection user input mechanism that is actuated to select the update package for uploading to the remote server system.

Example 6 is the computing system of any or all previous examples and further comprising:

an update certification component that is invoked to certify that the intermediate developer updates conform to a given set of update practices.

Example 7 is the computing system of any or all previous examples wherein the update download component generates an update selection user input mechanism that is actuated to select a set of manufacturer updates to download for implementation.

Example 8 is a computing system, comprising:

an update selector component that displays an update selection user input mechanism that is actuated to select a set of updates to be downloaded to the computing system, for installation, the update selector component accessing available updates to the computing system from a remote server system, the available updates including manufacturer updates to a base computer system and intermediate developer updates, and the update selection user input mechanism displaying the available updates for selection; and

an update downloader component that displays a download user input mechanism to download selected updates, from the available updates, and, in response to actuation of the download user input mechanism, downloads the selected updates from the remote server system to the computing system.

Example 9 is the computing system of any or all previous examples wherein the base computer system comprises a base business system and wherein the intermediate developer updates include updates to a modified version of the base business system, to implement the manufacturer updates in the modified version.

Example 10 is the computing system of any or all previous examples wherein the selected updates include the intermediate developer updates, and further comprising:

an update evaluator that evaluates an impact of the selected updates on the modified version of the base business system.

Example 11 is the computing system of any or all previous examples and further comprising:

an update installer component that displays an install user input mechanism and that installs the selected updates on the computing system in response to actuation of the install user input mechanism.

Example 12 is the computing system of any or all previous examples wherein the update selector component displays a set of filter user input mechanisms that are actuated to filter the available updates, for evaluation by the update evaluator, based on a set of filter criteria.

Example 13 is the computing system of any or all previous examples wherein the update evaluator evaluates an impact of the intermediate developer updates against the computing system in terms of conflicts introduced by the intermediate developer updates.

Example 14 is the computing system of any or all previous examples wherein the update evaluator evaluates an impact of the intermediate developer updates in terms of which models in the computing system are affected by the intermediate developer updates.

Example 15 is the computing system of claim 13 wherein the update evaluator evaluates an impact of the intermediate developer updates in terms of which layers in the computing system are affected by the intermediate developer updates.

Example 16 is the computing system of any or all previous examples wherein the update evaluator evaluates an impact of the intermediate developer updates in terms of which business processes in the computing system are affected by the intermediate developer updates.

Example 17 is the computing system of any or all previous examples wherein the update selector component displays a search user input mechanism that is actuated to search the intermediate developer updates based on a set of search criteria.

Example 18 is a method, comprising:

displaying a download user input mechanism at a computing system;

in response to actuation of the download user input mechanism, accessing, at a remote server system, manufacturer updates to a base system and downloading the manufacturer updates for implementation, through intermediate developer updates, at the computing system;

generating the intermediate developer updates, based on the manufacturer updates;

displaying an upload user input mechanism; and

in response to actuation of the upload user input mechanism, uploading the intermediate developer updates, that implement the downloaded manufacturer updates, to the remote server system for access and installation at an end user system.

Example 19 is the method of any or all previous examples wherein the base system comprises a base business system and wherein the manufacturer updates comprise manufacturer updates to the base business system, and wherein uploading comprises:

displaying a package generation user input mechanism; and

in response to actuation of the package generation user input mechanism, generating an update package including the intermediate developer updates and the downloaded manufacturer updates.

Example 20 is the method of any or all previous examples wherein displaying a download selection user input mechanism comprises:

displaying an update selection user input mechanism that is actuated to select a set of manufacturer updates to download for implementation.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computing system, comprising:
an update download component configured to:
generate a download user input mechanism that is actuatable to access, from a remote server system, a manufacturer update to a base system; and
based on an indication of actuation of the download user input mechanism, download the manufacturer update for implementation of the manufacturer update to a customized base system through an intermediate customization, the customized base system comprising a customized version of the base system;
an update functionality component configured to:
generate an update user input mechanism; and
based on an indication of actuation of the update user input mechanism, generate the intermediate customization that incorporates the manufacturer update into the customized base system to obtain an updated, customized base system; and
an update upload component configured to:
generate an upload user input mechanism; and
based on an indication of actuation of the upload user input mechanism, upload the intermediate customization to the remote server system for access and installation at an end user system.

2. The computing system of claim 1 wherein the base system comprises a base business system.

3. The computing system of claim 1 and further comprising:
an update package generator configured generate an update package including the intermediate customization and the downloaded manufacturer update.

4. The computing system of claim 3 wherein the update package generator is configured to generate package generation user input mechanisms comprising a name input mechanism that is actuatable to define a name for the update package, a model input mechanism that is actuatable to identify an update model corresponding to the update package, and a related update mechanism that is actuatable to identify the manufacturer update that is related to the update package.

5. The computing system of claim 3 wherein the update upload component is configured to generate a package selection user input mechanism that is actuatable to select the update package for uploading to the remote server system.

6. The computing system of claim 3 and further comprising:
an update certification component that is invoked to certify that the intermediate customization conforms to a given update practice.

7. The computing system of claim 1 wherein the update download component is configured to generate an update selection user input mechanism that is actuatable to select the manufacturer update to download for implementation.

8. A computing system, comprising:
an update selector component configured to generate an update user interface display that displays a set of available updates and includes an update selection user input mechanism that is actuatable to select an update from the set of available updates to be downloaded to the computing system, for installation, the set of available updates including a manufacturer update to a base system and an intermediate customization update, the intermediate customization update comprising an update to a customized version of the base system to incorporate the manufacturer update into the customized version; and
an update downloader component configured to generate a download user input mechanism to download the selected update from the remote server system to the computing system.

9. (canceled)

10. The computing system of claim 8 wherein the selected update includes the intermediate customization update, and further comprising:
update evaluator configured to evaluated an impact of the selected update on the customized version of the base system.

11. The computing system of claim 10 and further comprising:
in update installer component configured to generate an install user input mechanism and to install the selected update on the computing system in response to actuation of the install user input mechanism.

12. The computing system of claim 11 wherein the update selector component is configured to display a filter user input mechanism that is actuatable to filter the available updates, for evaluation by the update evaluator, based on filter criteria.

13. The computing system of claim 10 wherein the update evaluator is configured to evaluate an impact of the intermediate customization update against the computing system in terms of a conflict introduced by the intermediate customization update.

14. The computing system of claim 13 wherein the update evaluator is configured to evaluate an impact of the intermediate customization update in terms of which model in the computing system is affected by the intermediate customization update.

15. The computing system of claim 13 wherein the update evaluator evaluates an impact of the intermediate customization update in terms of which layer in the computing system is affected by the intermediate customization update.

16. The computing system of claim 13 wherein the update evaluator is configured to evaluate an impact of the intermediate customization update in terms of which process in the computing system are affected by the intermediate customization update.

17. The computing system of claim 11 wherein the update selector component is configured to generate a search user input mechanism that is actuatable to search the intermediate customization update based on search criteria.

18. A method, comprising:
downloading, from a remote server system, a manufacturer update to a base system for implementation of the manufacturer update to a customized base system through an intermediate customization, the customized base system comprising a customized version of the base system;
generating the intermediate customization that incorporates the manufacturer update into the customized base system to obtain an updated, customized base system; and
uploading the intermediate customization, that implements the downloaded manufacturer update to the customized base system, to the remote server system for access and installation at an end user system.

19. The method of claim 18 wherein uploading comprises:
instructing the display device to display a package generation user input mechanism; and
in response to receiving an indication of actuation of the package generation user input generating an update package including the intermediate customization and the downloaded manufacturer update.

20. The method of claim 18, and further comprising:
instructing a display device to display a download user input mechanism at a computing system;
based on an indication of actuation of the download user input mechanism, downloading the manufacturer update from the remote server system.

21. The method of claim 20, wherein instructing a display device to display a download selection user input mechanism comprises:
instructing the display device to display an update selection user input mechanism that is actuated to select one or more manufacturer updates to download to the computing system.
